(19) United States
(12) Patent Application Publication
(10) Pub. No.: US 2012/0317163 A1
(43) Pub. Date: Dec. 13, 2012

(54) System and Method for Media Evaluation

(76) Inventors: Brendon P. Cassidy, Venice, CA (US); Zack Zalon, Sherman Oaks, CA (US)

(21) Appl. No.: 13/352,144

(22) Filed: Jan. 17, 2012

Related U.S. Application Data
(60) Provisional application No. 61/433,517, filed on Jan. 17, 2011.

(51) Int. Cl. G06F 15/16

(52) U.S. Cl. 709/201

(57) ABSTRACT

A media evaluation system is provided that includes a release module configured for uploading and description of user-media by a user, a screener module, and an opportunity engine configured to compare predetermined criteria to the description of the user-media. The opportunity engine is configured to provide opportunities to the user when the predetermined criteria are met.

### CROSS REFERENCE TO RELATED APPLICATIONS

This application claims priority to U.S. Provisional Patent Application No. 61/433,517 filed on Jan. 17, 2011, titled “System and Method for Media Evaluation and Opportunity Connection”, to Brendon P. Cassidy, et al., which is incorporated herein by reference in its entirety.

### FIELD

The present application is related to a system and method for media evaluation.

### BACKGROUND

The media industry, including music, typically comprises a complex and arduous process to provide exposure for new music and/or artists. The process may include years of live acts, small scale performances, and submission of demo media before gaining enough notoriety to be considered for mass distribution, if ever.

Moreover, the industry may rely on individuals as “spotters” such as Artist and Repertoire scouts (“A&R”) that are adept at identifying new talent and may introduce the new talent to a recording label. However, an artist (e.g., musician) would have to get the opportunity to perform for A&R and/or provide a demonstration recording. Due to the large number of bands/acts in the market, a musician may have difficulty even having the opportunity to demo for A&R even after years of self-promotion. Moreover, even after significant effort, without some amount of luck an artist may never have the opportunity to demo.

Typically, only a select few had the chance to be identified, filtered and offered opportunities for their media. Moreover, the potential for identification was merely local.

Thus, there exists a need for a simplified and expedited method for promotion of new artist and media to have the opportunity for being recognized and considered for mass identification and distribution of media. There is also a need to broaden access to larger markets, including the Internet, so that the industry may be reinvigorated and provide artists with greater reach.

### BRIEF DESCRIPTION OF THE DRAWINGS

The present invention will now be described, by way of example, with reference to the accompanying drawings, in which:

FIG. 1 shows a high level example of a system and method for media evaluation.

FIG. 2 shows a detailed view of the system and method for media evaluation.

FIG. 3 shows a flow diagram of creating a release.

FIG. 4 shows a flow diagram of an opportunity engine.

FIG. 5 shows a flow diagram of a screener/moderator.

FIG. 6 shows a home page user interface for the system and method for media evaluation.

FIG. 7 shows a “screener/moderator release-screening” user interface for the system and method for media evaluation.

FIG. 8 shows a “release—star rating” user interface for the system and method for media evaluation.

FIG. 9 shows a “release—select genre/styles” user interface for the system and method for media evaluation.

FIG. 10 shows a “release—select similar artists” user interface for the system and method for media evaluation.

FIG. 11 shows a “release—select qualities” user interface for the system and method for media evaluation.

FIG. 12 shows a “release—select opportunities” user interface for the system and method for media evaluation.

FIG. 13 shows a “release—enter notes for release details” user interface for the system and method for media evaluation.

FIG. 14 shows a “release—track details” user interface for the system and method for media evaluation.

FIG. 15 shows a “release—artist information” user interface for the system and method for media evaluation.

FIG. 16 shows a “screener/moderator—pending” user interface for the system and method for media evaluation.

FIG. 17 shows a “screener/moderator—reviewed aggregate” user interface for the system and method for media evaluation.

FIG. 18 shows a “screener/moderator—reviewed notes” user interface for the system and method for media evaluation.

FIG. 19 shows a “screener/moderator—reviewed release details” user interface for the system and method for media evaluation.

FIG. 20 shows a “screener/moderator—reviewed track details” user interface for the system and method for media evaluation.

FIG. 21 shows a “screener/moderator—reviewed artist information” user interface for the system and method for media evaluation.

FIG. 22 shows a “screener/moderator—reviewed sent” user interface for the system and method for media evaluation.

FIG. 23 shows a first portion, including a feedback summary and feedback comparison, of a feedback summary report.

FIG. 24 shows a second portion, including an attribute breakdown, of a feedback summary report.

FIGS. 25 and 26 show a third portion and fourth portion, including detailed feedback results, of a feedback summary report.

FIGS. 27 and 28 shows a fifth portion and a sixth portion, including qualities that may need work and potential opportunities, of a feedback summary report.

FIGS. 29 to 43 show a dashboard and opportunity management interface.

FIGS. 44 to 46 show an opportunity browsing interface.

FIGS. 47 to 54 show an opportunity administration interface.

### DETAILED DESCRIPTION

Referring now to the drawings, illustrative embodiments are shown in detail. Although the drawings represent the embodiments, the drawings are not necessarily to scale and certain features may be exaggerated to better illustrate and explain an embodiment. Further, the embodiments described herein are not intended to be exhaustive or otherwise limit or restrict the invention to the precise form and configuration shown in the drawings and disclosed in the following detailed description.

In general, a system and method for media evaluation may include an online registration system that allows a user (e.g., an artist, media creator, promoter, producer, performer, band, solo-artist, group, etc.) to upload media for evaluation by automated process and/or human specialists. The system may include a user interface allowing the creation of a master profile for the user and allow for sub-profiles. The profiles may also be shared by group, such as a band.

An opportunity engine may also the artist to go to their opportunity dashboard and receive opportunities they qualified for, or automatic opportunities. Each opportunity may have legal requirements (e.g., a license) that the artist may review and decide to agree to if appropriate.

The user interface may include a paged format or an inline format. An inline format may allow the user to input the information and view it as a whole rather than dealing with information on various pages requiring them to go “back” (e.g., in a browser) to correct or change information. The inline format may also lend itself to receiving better or more consistent information since the user can see substantially the entirety of the information being provided.

While entering the information (e.g., such as basic demographic information about the artist) the system may provide for useful callouts in the user interface to guide the artist through the process. In general, a user may create a profile and begin uploading the media (e.g., music, video, etc.) in the background while inputting additional information or reviewing information provided by the user interface.

The user may create a release that may include an album. The album would include a description, cover art, and the name of each track which may be uploaded. Other information may include what the media “sounds-like” as a reference and the user may be able to pick from a multitude of choices to assist in describing the release and each track. An example of expedited and targeted entry may include the user interface providing for “similar artist selection”. If the user can identify an existing artist with a similar style, then much of the information may be automatically populated when the user identifies the similar artist, which may increase efficiency while also improving the quality and completeness of the upload information.

After the user completes the process to create a release, the system may evaluate the information and media for completeness. Moreover, prior to the media being evaluated, certain other items such as legal requirements (e.g., legal documents related to ownership, distribution etc. of the media) may be reviewed by the user and consented to before proceeding. If the user does not consent to the legal requirements, the system may remove the release and the process may end.

When all requirements are met, the system may then begin to assess the release for possible promotion or opportunity matching. The release may be reviewed for genre (acid jazz, byzantine chant, easy listening and pop), category, language, explicitness, subject matter, etc. The reviewer may be a specialist (e.g., a person trained in reviewing media) or an automated process. This reviewer may also be considered a screener/moderator with the ability to override what the user has input. For example, the screener/moderator may review the data input by the user while uploading the release as a starting point. However, the screener/moderator may also have the ability to override any or all of the user inputs to correct them or make more appropriate attributions.

Additionally, the screener/moderator may enforce policies of the system which may include removing or suppressing certain media. Reasons may include inappropriate content such as lyrics, artwork, video, etc. or where the user has not made any effort to correctly identify the media uploaded for the release. The screener/moderator may also identify and remove or suppress media (or related other information) that is against policy or gives rise to legal concerns or considerations (e.g., a potential copyright violation).

Upon completion of the screener/moderator process, the release may be approved and become a classified release. The user may then receive a report detailing the release and the information corrected/added by the screener/moderator, comparison information to the user's peers, and/or helpful hints. For example, the report may include the classified release genre, style, and qualities of the release. Hints may include areas for improvement such as performance (energy, timing, etc.), songwriting, and production (arrangement, quality, etc.)

Other information in a report may include feedback comparison of the releases to similar releases (determined by the information in the classified release) and all releases. Thus, the user may get a sense as to their “score” with respect to similar media and the media as a whole. The feedback comparison may also include a distribution showing the statistical breakdown of scores over the rating range to better show whether the user is in the “middle” or a long tail statistically.

The feedback comparison may also include detailed results that may include prepared statements and/or customized statements from the screener moderator. The detailed results may be considered by the user to improve their overall presentation of the media. The detailed results may include examples of similar artists, explanations about the scores, and links to helpful information to assist the user with improving their skills and/or presentation.

Moreover, once released, the system may begin providing other services to the user, as well as providing the media to potential candidates for review, e.g., through opportunity matching. Opportunity matching, for example, may include “automatic” matches, such as discounts to music-related stores. The opportunity matching may also include potential introductions for distribution with large-scale media enterprises, corporate enterprises, or other potential consumers of the media. Examples of opportunities may include industry education courses, licensing, touring and “open-mic” opportunities. Where the system provides for a broad audience of listeners, the system may also alert listeners having an interest in the classified release that the release exists and is available for their review. Thus, the new release may have an impact on a large number of people that have indicated their interest in the type of media and a following may result. In general, opportunity matching may be performed by an opportunity engine. The opportunity engine may be managed by the system to match users, and their media, with potential opportunities driven by a set of criteria. The opportunity engine may use an automatic and/or manual system to match media with criteria and provide the opportunity to the user as well as the opportunity provider.

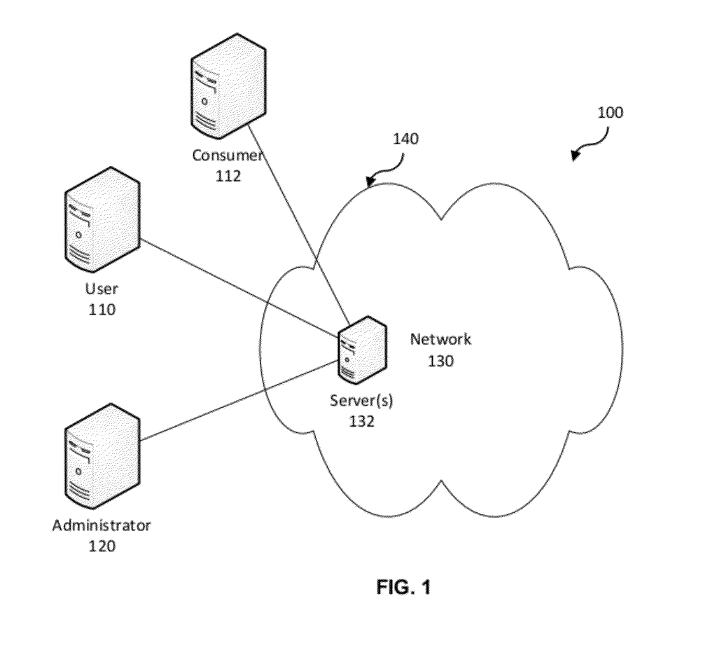

Turning now to the drawings, FIG. 1 shows a system and method for media evaluation 100. The system may include a media user 110, a media consumer 112, administrator 120, and general network 130 which may comprise one or more servers 132. Media user 110 may include an artist, a music group, a band, etc. The system may also include a media consumer 112 that could include the general public a business partner the publication group or a media promoter, etc. The system may also be based on a cloud infrastructure 140 for reduced cost, ease of modification, security/auditing, performance, and redundancy purposes.

Servers 132 may include general servers having persistent storage (e.g., disk), processing capabilities, as well as network communication capabilities. Moreover, servers 132 may be configured for specialized purposes such as web-servers, data storage (e.g., large persistent storage), highly transactional machines (e.g., databases), and data processing systems (e.g., for “sounds-like” matching or the like).

User 110 may include an end-user or another system. For example, where user 110 is an artist or a band, they may access system 100 using a personal computer, laptop or mobile computing device (e.g., a smart-phone). Alternatively, user 100 may be an automated system that could provide media and the associated information to system 100 using an application programming interface (“API”). In this way, the system 100 may be configured for use directly with a user 110 (e.g., an artist/band) or it may be configured for automated use with an organization having a catalog of media that can be interfaced to system 100 with an API.

Consumer 112 may be the person, organization or system that is providing opportunities to user 110. For example, consumer 112 may include a music store that is providing a discount to user 110. Alternatively, consumer 112 may be a corporation providing the opportunity to play the media on a radio/television channel or at a public venue. Consumer 112 may also include a user interface or by API driven when accessing another system.

Administrator 120 is shown as a single computing device in FIG. 1. However, administrator 120 may typically be configured as part of network 130 and may include multiple interfaces and hardware components that may be shared within the cloud infrastructure 140. For example, the administrator 120 may be a system administrator of system 100, or administrator 120 may be a screener/moderator with special permissions to access and modify the media uploaded and described by user 110.

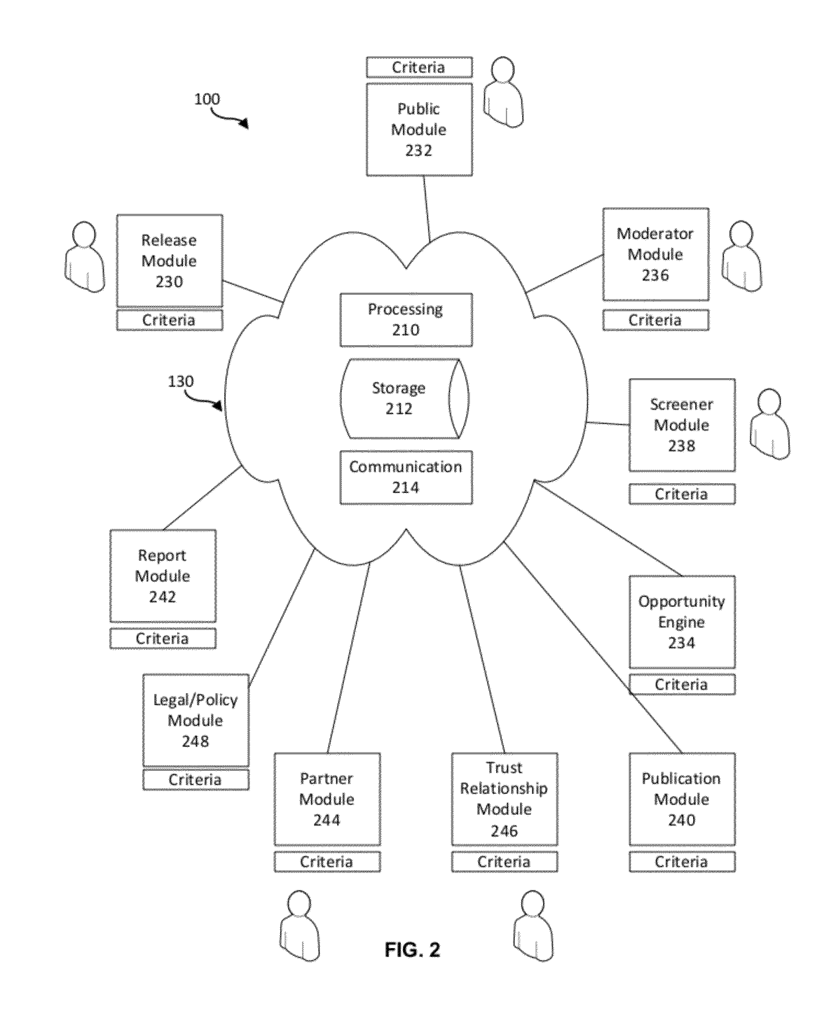

FIG. 2 shows a detailed view of an example of system 100. As shown, system 100 is simplified to include processing capability 210, storage capability 212, and communication capability 214. Each of these capabilities may be centralized (e.g., at a datacenter), they may be distributed, or they may use a combination of each. Moreover, communication capability 214 may include, but is not limited to, wired, optical, and wireless communication means, or a combination thereof. Storage capability 212 may include volatile storage and persistent storage or any combination thereof. Processing capability 210 generally includes central processing units (CPUs), but may also include specialized processing capability such as digital signal processors (DSPs) and/or stream processors (SPUs). As one of ordinary skill in the art will appreciate, the specific hardware/software configuration may be accomplished in a variety of ways.

The system includes various modules that perform functions and control access/use of information contained in the system 100. The system may include various modules including a release module 230, a public module 232, an opportunity engine 234, a moderator module 236, a screener module 238, a publication module 240, a report module 242, a partner module 244, a trust relationship module 246, and a legal/policy module 248. Each of the modules may have particular criteria assigned to it. The criteria may allow for inclusion or exclusion of certain potentially incoming media based on various inputs. Moreover, the criteria may also include or exclude certain media.

Release module 230 may include a user interface for the uploading and description of media by user 110. This may also include the rules, data, help information, and other information to assist and facilitate entry of a release by user 110. Moreover, release module 230 may include the persistent storage of the media, and all information related to user 110 and the release. The media and information may persist in storage 212, which may comprise a variety of storage mediums and techniques. For example, user information may be stored in a database while the larger media files (e.g., audio, video, and photo) may be stored in a traditional file system.

Public module 232 may comprise a public interface that allows random and/or registered users to access media. For example, where an artist allows (e.g., by legal agreement) media to be distributed to the public by some form of a license (e.g., a click-through agreement or inherent copyright rights), then public module 232 may promote the media based on certain criteria.

Opportunity engine 234 may take into account predetermined criteria for a consumer 112 (or a trust relationship) and can compare the predetermined criteria to the information recorded in storage 212. In general, opportunity engine 234 may have full access to any media and release information that is available in system 100. Opportunity engine 234 may be considered an automated system that receives information from consumers 112 in the form of criteria that may be mapped and compared with the user 110 information. In this way, opportunity engine 234 may automatically generate opportunities that match up with the expectations of user 110 as well as serve the business purpose of consumer 112. Opportunity engine 234 may perform an automated process of matching media to opportunities as an event driven system (i.e., soon after media is available) or it may use a scheduled approach (e.g., a periodic scheduler such as a daily run).

If opportunity engine 234 matches media with an opportunity, an opportunity alert may be sent to a user 110 to make them aware of the match. Similarly, when a match occurs, an opportunity alert may be sent to consumer 112. Alternatively, the metrics may be sent to consumer 112 which may allow the consumer 112 to further screen opportunities. In general, opportunity engine 234 may use any and/or all of the information user 110 input with the GUI, any modifications/additions by moderator 236 and/or screener 238. Storage 212 may hold the criteria to make a decision whether or not to provide an opportunity to user 110.

Opportunity engine 234 may also be considered to operate as a filter providing access to some media and not to others based on predetermined criteria setup by a moderator, system 100 (e.g., if configured for dynamic operation), by user 110 or consumer 112. Examples of filtering by user 110 may include a checkbox indication during the release definition wherein the user 110 may indicate whether they would like live music opportunities, radio/net broadcast opportunities, and/or retail discounts. Moreover, consumer 112 may specific availability, genre, and location etc. of the media that may be used as a filter. In this way, opportunity engine 234 may filter based on a variety of criteria from many sources, not only including user 110 or consumer 112, but also information developed such as whether an artist is gaining momentum or slowing down with bookings.

Moderator module 236 may include the ability to control all of the information related to user 110 as well as a release. Moderator module 236 is typically more sophisticated and may receive feedback from public module 232 (e.g., a complaint about the media content), a verification from legal/policy module 248 as to whether all items have been consented to, information from opportunity engine 234 that may signal additional review may be desirable (e.g., the media has qualified for an unusually high number of opportunities which may indicate it is more interesting), or whether trust relationship module 246 has an interest in the media. In general, moderator module 236, including the moderator themselves, have the ability to increase or decrease the significance of the media based on a wide range of inputs.

Screener module 238 may activate after user 110 enters the information using release module 230. Thus, screener module 238 may serve as a filter near the front-end of system 100. The screening may be more simplified and include a process to determine whether the media/release uploaded are ready to be added to system 100. Note that in some configurations, screener module 238 and moderator module 236 may be combined into a single logical block, possibly with a single person performing both functions, when appropriate.

Publication module 240 may be configured to push releases to consumer 112. This may include media that matches criteria determined by consumer 112, or matches criteria determined by system 100. For example, publication module 240 may send a track snippet (or link to a snippet) via electronic mail to a potential venue that seeks a new act of a predetermine genre. The proprietor of the venue may then sample the media and make a determination to book the act. Alternatively, the publication module 240 may match a sales opportunity for a music instrument business based on the type of music. For example, where the music uses guitars, the opportunity may be published for a sale on guitar equipment only to those users 110 uploading media that uses guitar.

Report module 242 may be configured to compare the information provided by user 110 and the media uploaded with the information stored in storage 220. In particular, report module 242 may compare and determine a score based on similar release information and all releases available in storage 220. Alternatively, report module 242 may use a subset of information that is adjustable for a time period (e.g., the last 5 years) or has different weighting (e.g., the “all releases” score may more heavily weight more recent releases in the determination). Additionally, report module 242 may generate and send the feedback report to user 110 that includes hints, explanations, and comparison information.

Partner module 244 may include an API to additional systems that are partnered with system 110 to provide information and or other support. For example, where system 100 does not include a full catalog of “sounds-like” information, system 100 may connect with and use partner module 244 to outsource the task of automatically determining genre based on the media content itself (or a snippet of the media). Alternatively, partner module 244 may be an open or licensed API allowing 3^{rd} parties to develop applications that use system 100.

Trust relationship module 246 may include methods and criteria for trusted partners such as record labels and preferred venues. For example, when a screener/moderator identifies potential high-value artists and/or media, they may refer these to a trusted consumer 112. In general, trust relationship module 246 may function similarly to consumer 112 (see FIG. 1) but may implicitly require a higher level of confidence in the screener/moderator. Moreover, the reporting structure may include more specialized information to allow greater initial scrutiny of the media. In some respects, trust relationship module 246 may function as a quasi-automated A&R with some non-automated judgment factored into a decision.

Legal/policy module 248 may include a set of rules and/or criteria that system 100, user 110, screener 238, moderator 236 may comply with. For example, legal/policy module 248 may require the user 110 to comply with certain legal requirements before a release is available for review by a screener/moderator, and before the media would be able for review by an opportunity.

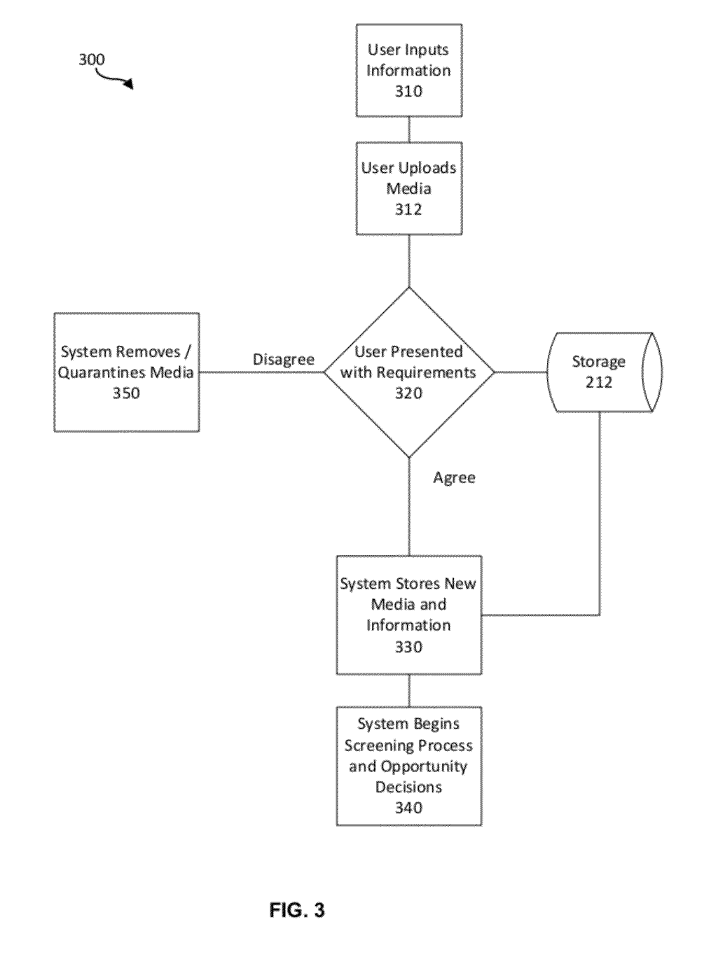

FIG. 3 shows a flow diagram 300 of creating a release. In a first step 310, user 110 may input information to system 100 such as the artist name, demographic information, album name, track names, etc. In step 312, user 110 may upload the media files to system 110.

In step 320, user 110 may be presented with agreements. These may be in the form of click-through licenses, or electronic signature style agreements. The agreements may be legal in nature and be pulled from storage 212 (see FIG. 2). Moreover, the agreements may be territorial by nature allowing for various agreements to be presented based on geographic location whether it be different states of the United States of America, or different languages such as Spanish, Chinese, and German etc.

If user 110 consents to the agreements, control proceeds to step 330 where the system stores the newly uploaded media and information to storage 212. The system may then continue and begin the screening process 340 and start the opportunity engine for the new media.

If user 110 does not consent to the agreements, the system may remove or quarantine 350 the media and any associated information. This may be to prevent use, review, or inadvertent distribution of the media without an agreement in place on the scope of rights.

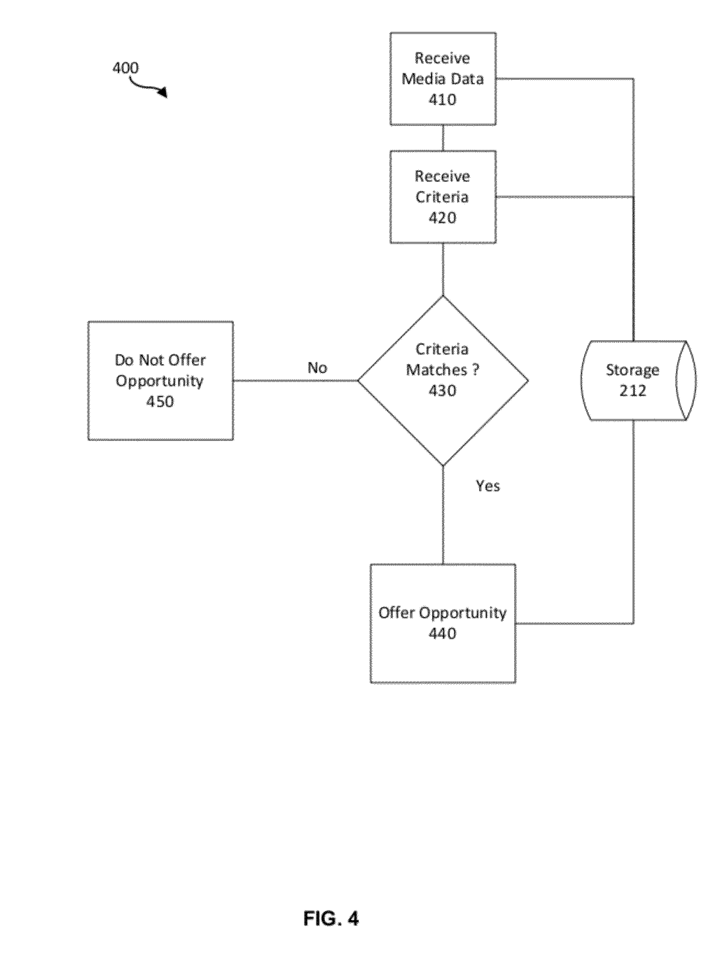

FIG. 4 shows a flow diagram 400 of an opportunity engine.

At step 410, the opportunity engine may receive media data. This may include the information provided by user 110, as well as any information provided by a moderator/screener, and any information provided by an automated process (e.g., “automated sounds-like” database etc.). The general idea is that data is retrieved that describes the media in a manner comparable to predetermined criteria. The media data may be retrieved from storage 212 or other data store.

At step 420, the criteria are received. The criteria relate to the parameters of providing or not providing an offer. These criteria may be widely based on general concepts (such as star ratings) or they may be based on geographic location or proximity (e.g., a potential opportunity may be for a low-paying gig in Omaha but the band is in Los Angeles, making the opportunity inefficient), availability, the closeness of user-input information to screened/moderated information, the closeness of similarity with artists that come up as “sounds-like” artists, as well as the genre, etc. Criteria may be retrieved from storage 212 or other data store.

At step 430, the release data is compared with the criteria to determine a match or not. If there is not a match, the offer associated with the tested criteria is not offered 450. If there is a match, the opportunity may be offered 440. At this stage, a screener/moderator may make manual adjustments. It is important to note that steps shown herein, including but not limited to steps 410-450, may be processed numerous times for various opportunities and various media, etc.

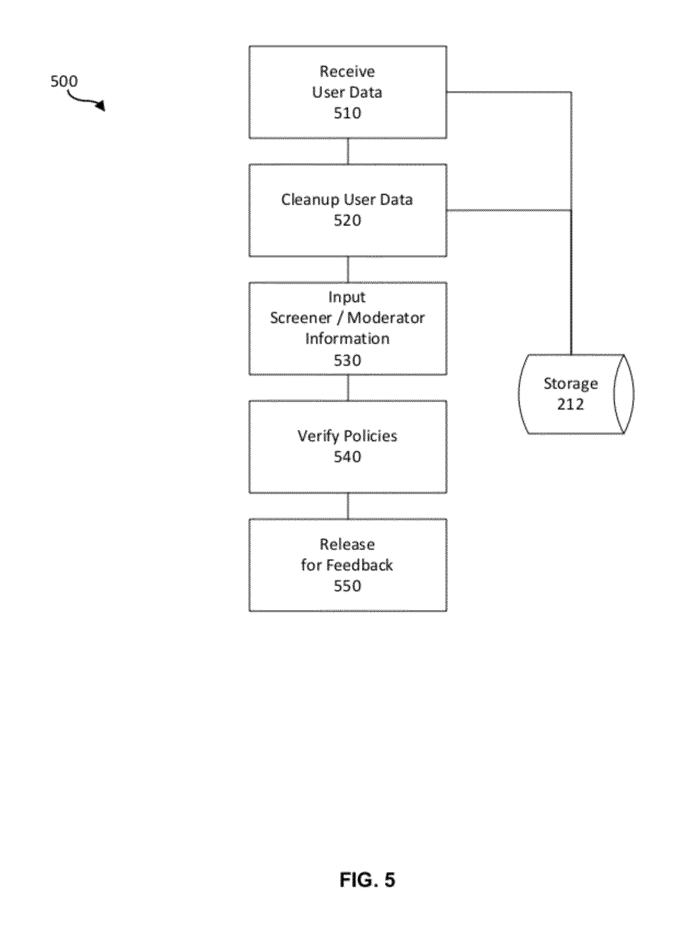

FIG. 5 shows a flow diagram 500 of a screener/moderator. In step 510, user data is received. This may be the manually entered user-data when the media is uploaded or it may be corrected information. In either event, the media may be persisted in storage 212. In step 520, the screener/moderator may cleanup the user data. Cleanup may be performed by the screener/moderator if the artist has misclassified their music or otherwise entered inaccurate or incomplete information. The corrected information may then be persisted back to storage 212. In step 530, the screener/moderator may input additional information, such as notes, star ratings, and selection of a solo song.

In step 540, the screener/moderator may review the policies and determine whether the media is able to continue with the process or if certain requirements are not met. For example, the legal aspects of storing and potentially distributing copyrightable materials must be attended to before action is taken with the media. Additionally, grants of license and or hold-harmless provisions may require acceptance by the user.

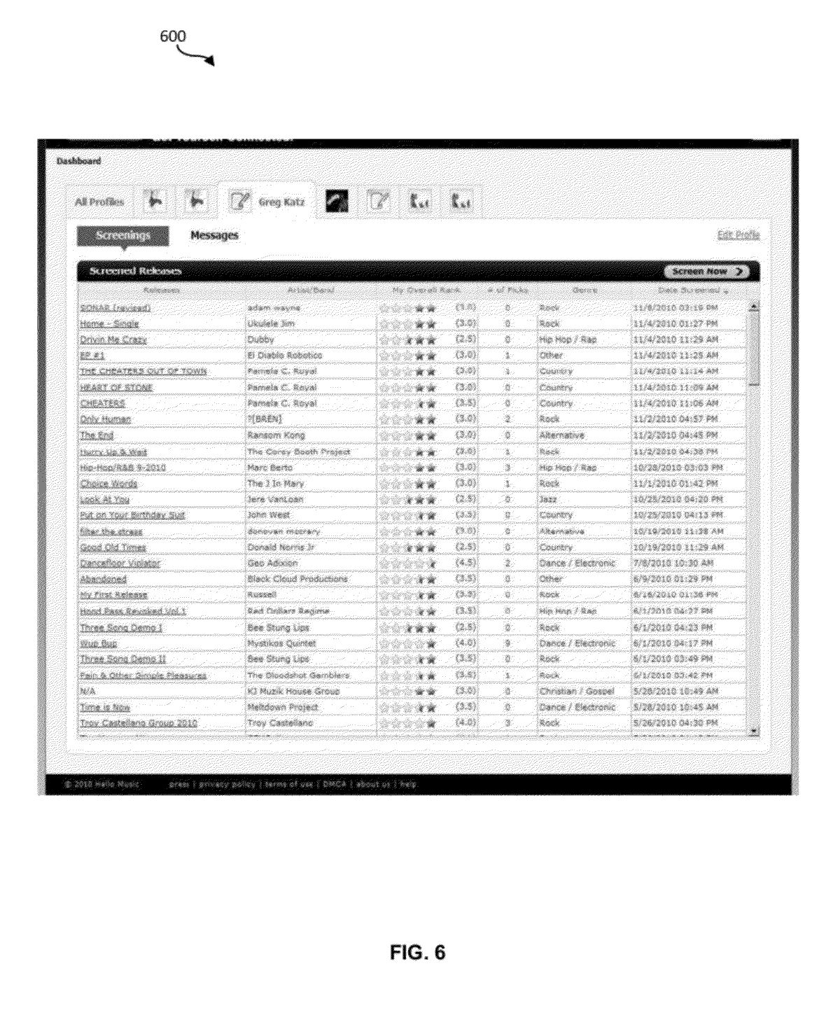

FIG. 6 shows a home page user interface 600 for the system and method for media evaluation 100. The screener/moderator may use this profile page to access the media for screening/moderating that are assigned to them. The columns generally indicate the release, the artist/band, the overall rank of the release, the number of picks, the genre and the date screened. The screener moderator may view home page user interface 600 and select a new release for screening or select an already screened release for re-screening. In general, system 100 will populate the data for home page user interface 600, including determining the rank and certain other information. However, the genre, release name and artist/band name may be input by user 110 and stored for display for the administrator 120 (e.g., a screener/moderator). As shown, the top tabs on the page indicate that the screener/moderator may view other profiles.

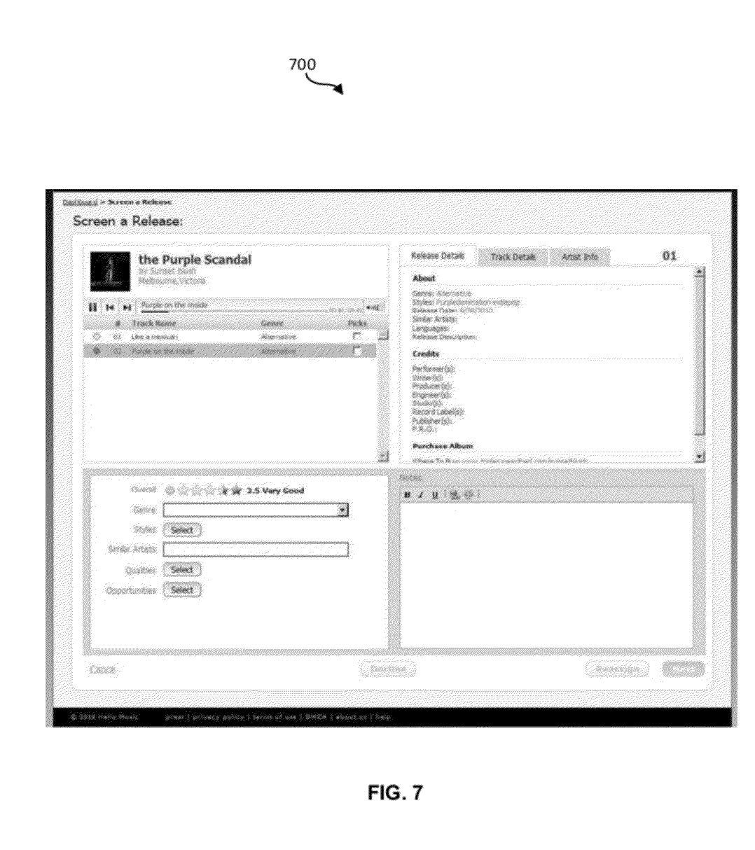

FIG. 7 shows a “screener/moderator—release screening” user interface 700 for the system and method for media evaluation 100. The release may include the track name, group name, hometown, the media (e.g., tracks) themselves, an input for overall rating, genre styles, similar artists, qualities and opportunities. The screener/moderator may enter and/or correct the information that will be stored in data store 210.

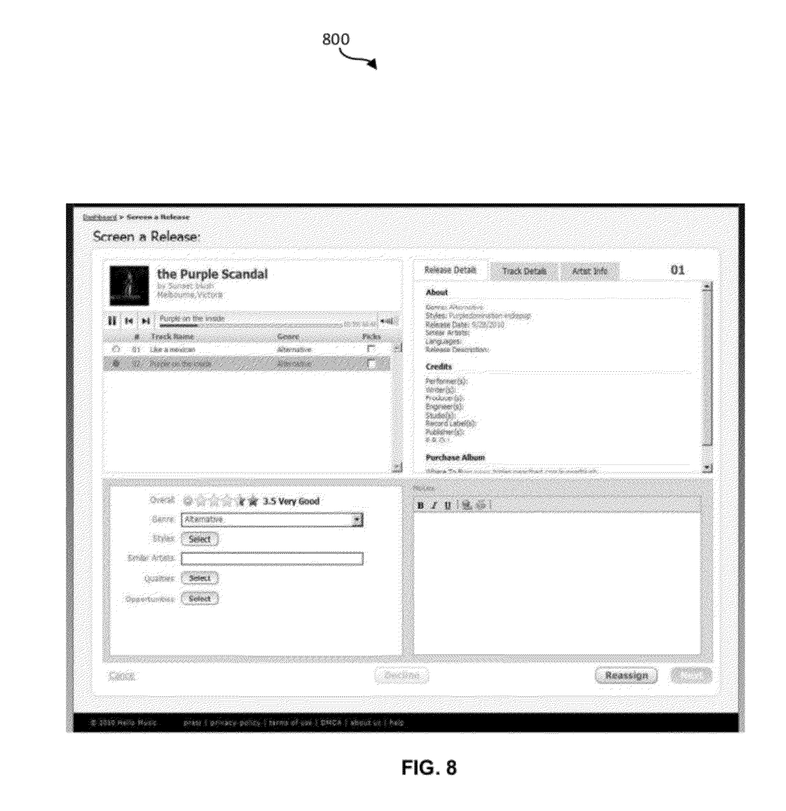

FIG. 8 shows a “release—star rating” user interface 800 for the system and method for media evaluation. Here, a screener/moderator has inputted 3.5 stars and a “very good” rating, and also selected alternative as the genre.

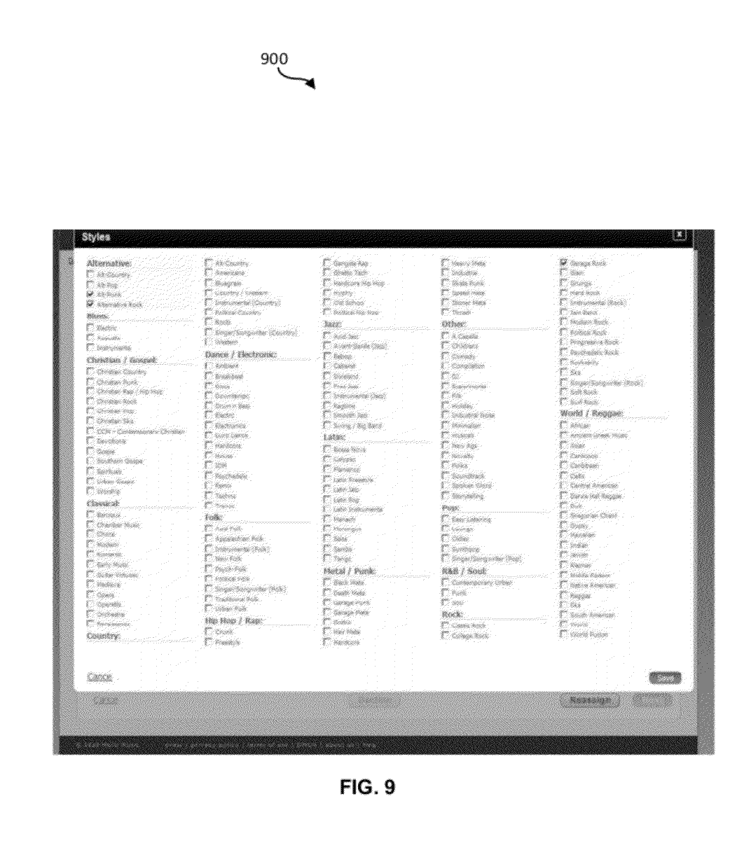

FIG. 9 shows a “release—select genre/styles” user interface 900 for the system and method for media evaluation. When the screener/moderator selects the genre after listening to the media, a helpful popup list of available genres may be presented. The screener/moderator may select more than one style or genre to describe the media. Selection from a known list reduces errors or inconsistencies attributed to the media presented.

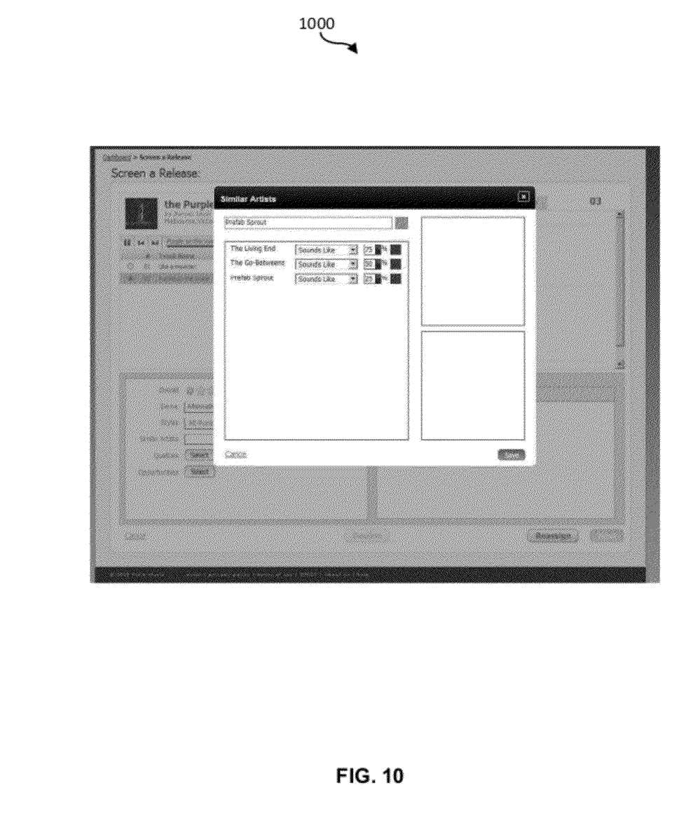

FIG. 10 shows a “release—select similar artists” user interface 1000 for the system and method for media evaluation. The screener/moderator may pick from various artists that sound like the media uploaded and provide a blended “sounds-like” rating. For example, one artist providing media for screening may be assigned a 75% sounds-like rating to similar artist A. At the same time, they may be assigned a 50% sounds-like rating to similar artist C. And if appropriate, a third assignment of a sounds-like rating may be applied at 25%. It is important to note that the “sounds-like” attribution could be changed, as well as the percentage attribution. For example, media could be assigned 100% “sounds-like” scores for multiple similar artists, or alternatively 10% for a single artist. The screener/moderator criteria and workflow may provide the minimum level of “sounds-like” information that is acceptable to process the uploaded media. Moreover, the “sounds-like” attribution could be automatically generated from a database of media files. Alternatively, the “sounds-like” information could be automatically suggested by system 100 to the screener/moderator for verification and final assignment.

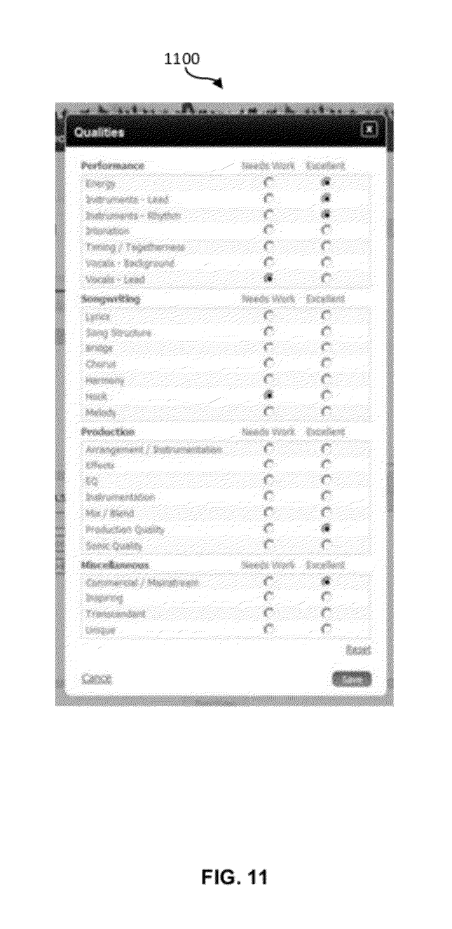

FIG. 11 shows a “release—select qualities” user interface 1100 for the system and method for media evaluation. The qualities may include areas such as performance, songwriting, production, and miscellaneous. They may simply grade as “needs work” or “excellent”. Alternatively, they could use a sliding scale or star system to provide more granular information. However, with such subjective quality grading, a more granular assignment may be desirable.

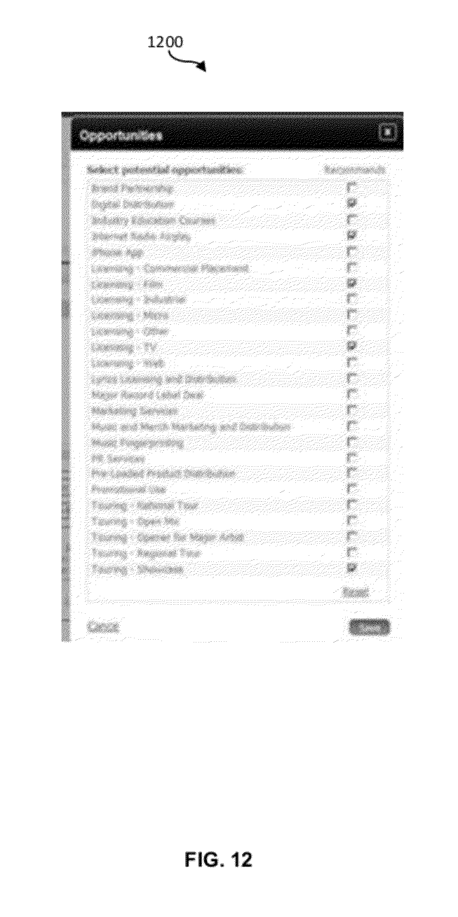

FIG. 12 shows a “release—select opportunities” user interface 1200 for the system and method for media evaluation. The system 100 may automatically recommend certain potential opportunities based on the criteria (see FIG. 2) and the screener/moderator may also use their experience and opinion to determine which opportunities will be provided. The system 100 may automatically suppress certain opportunities based on criteria determined by consumer 112. For example, where consumer 112 does not wish to present a reggae genre with an opportunity, they may exclude reggae genre in the criteria. Alternatively, they may include other genres but not reggae to achieve a similar result. As shown, the opportunity engine has the ability to be fine-tuned based on the experience and policies of the screener/moderator.

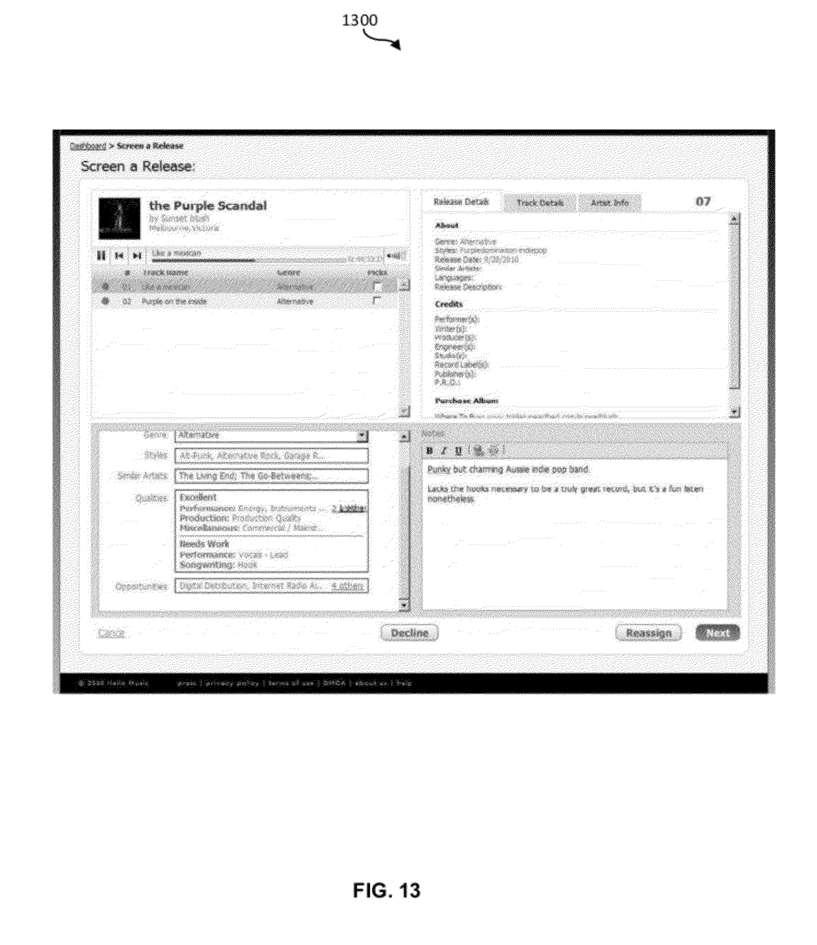

FIG. 13 shows a “release—enter notes for release details” user interface 1300 for the system and method for media evaluation. The screener/moderator may enter notes stored with the media contemporaneous with the review. In this way, the initial thoughts of an experienced and trained screener/moderator may be kept for later use. For example, if the trust relationship module 246 chooses to look at the media, such notes may be forwarded to the consumer 112. Alternatively, these notes may be given to the media owner for review and for use by support staff should the media owner contact support for an explanation of a rating or lack of opportunities.

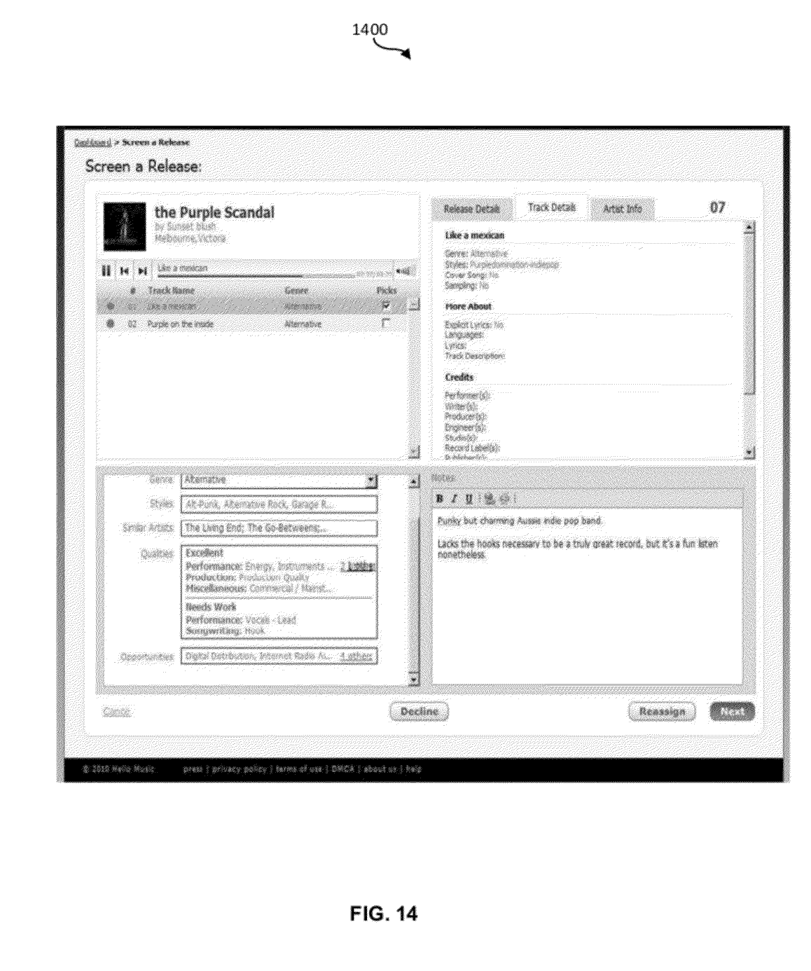

FIG. 14 shows a “release—track details” user interface 1400 for the system and method for media evaluation. Similar to FIG. 13, details may be entered for later use and review. However, the details shown in FIG. 14 relate to particular tracks of the media.

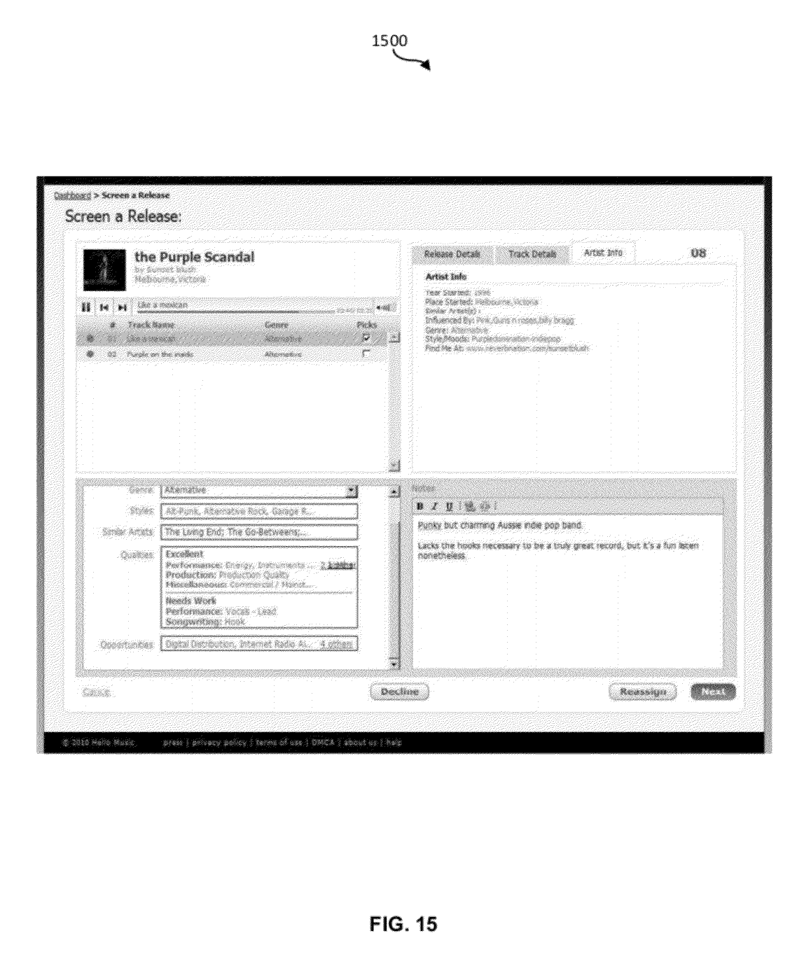

FIG. 15 shows a “release—artist information” user interface 1500 for the system and method for media evaluation. Similar to FIG. 13, details may be entered for later use and review. However, the details shown in FIG. 15 relate to artist information.

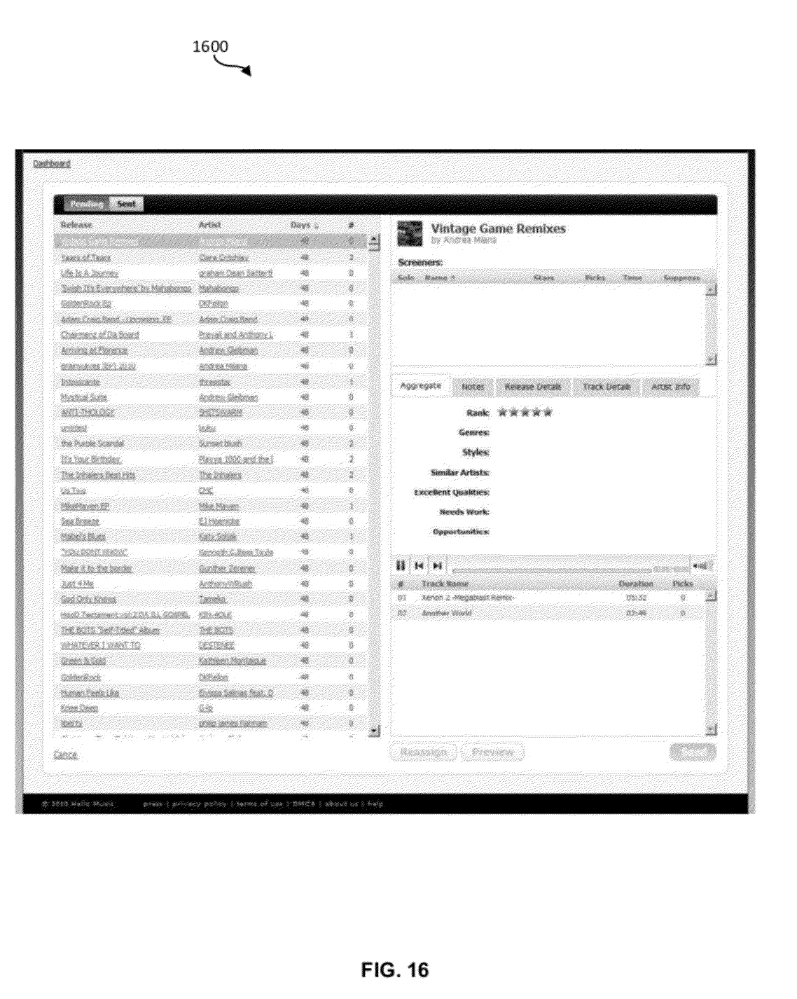

FIG. 16 shows a “screener/moderator—pending” user interface 1600 for the system and method for media evaluation. The screener/moderator may view media that has been screened and is about to be sent out to the system, and feedback back to the media owner. The screener/moderator may view pending or sent information, and may cancel a pending transaction if desirable.

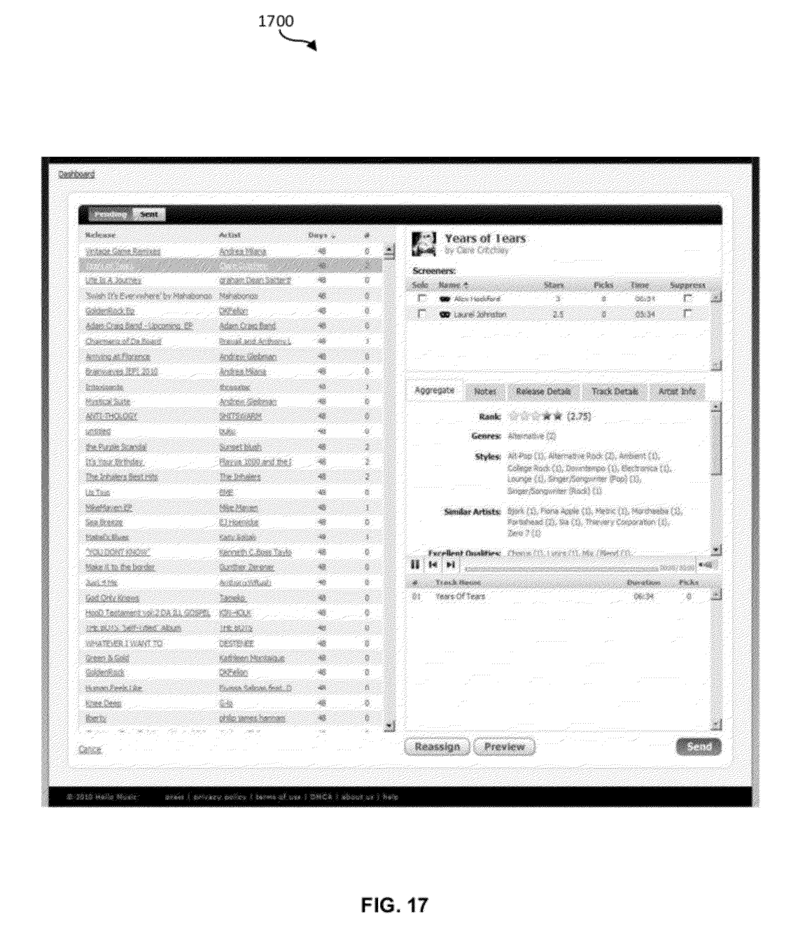

FIG. 17 shows a “screener/moderator—reviewed aggregate” user interface 1700 for the system and method for media evaluation. The screener/moderator may view certain tracks in aggregate for a particular user 110. For example, where multiple media items are uploaded, the aggregate view provides an averaging of rank (stars) as well as provides an aggregation of styles and similar artists to get a macroscopic view of the user 110.

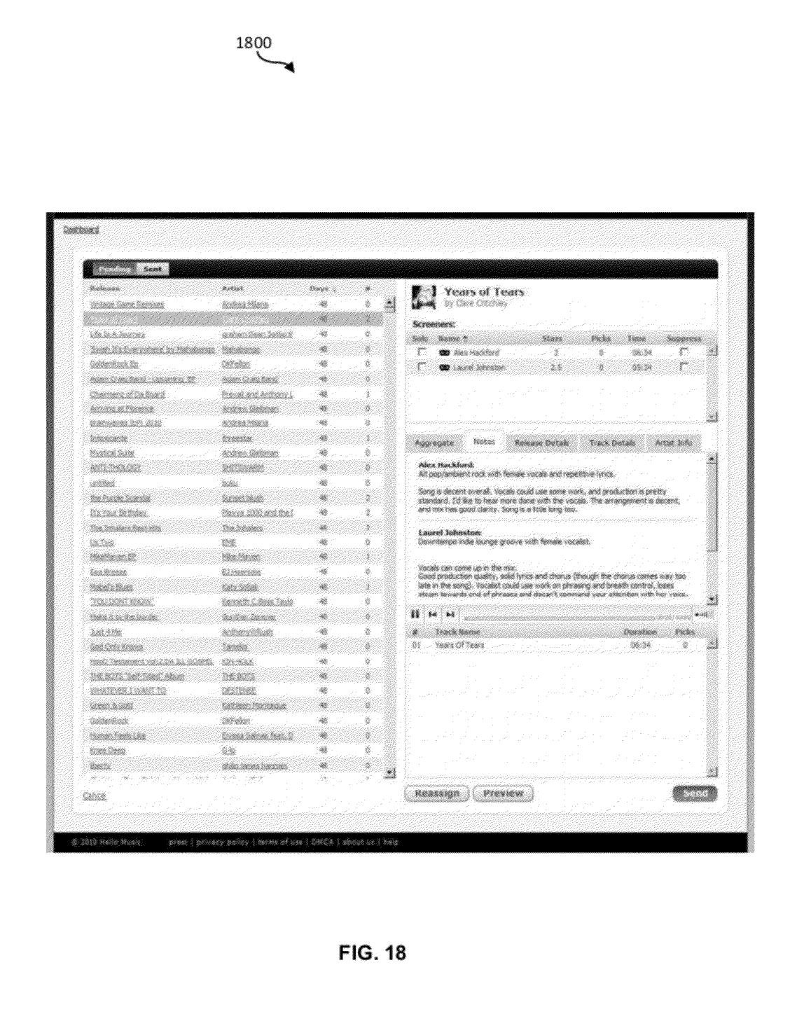

FIG. 18 shows a “screener/moderator—reviewed notes” user interface 1800 for the system and method for media evaluation. Here, a screener/moderator may view notes entered related to (see above FIGS. 14-16) in aggregate to achieve a sense as to the overall reviews and consistency of the reviews.

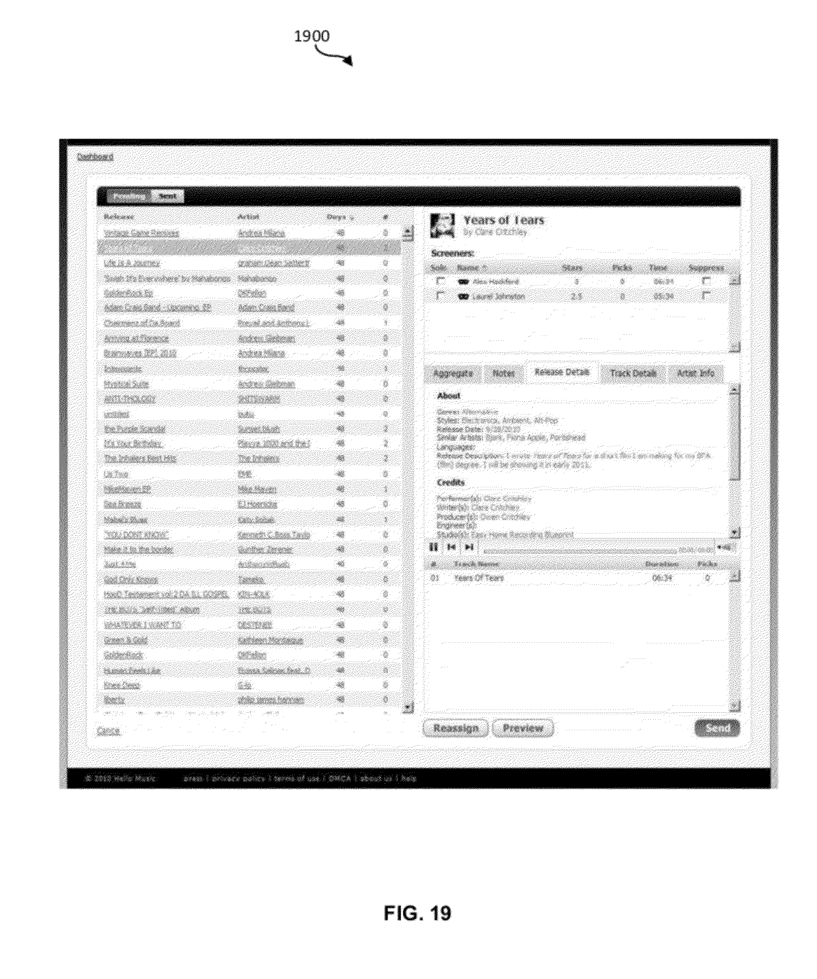

FIG. 19 shows a “screener/moderator—reviewed release details” user interface 1900 for the system and method for media evaluation. Here, a screener/moderator may view release details related to the media.

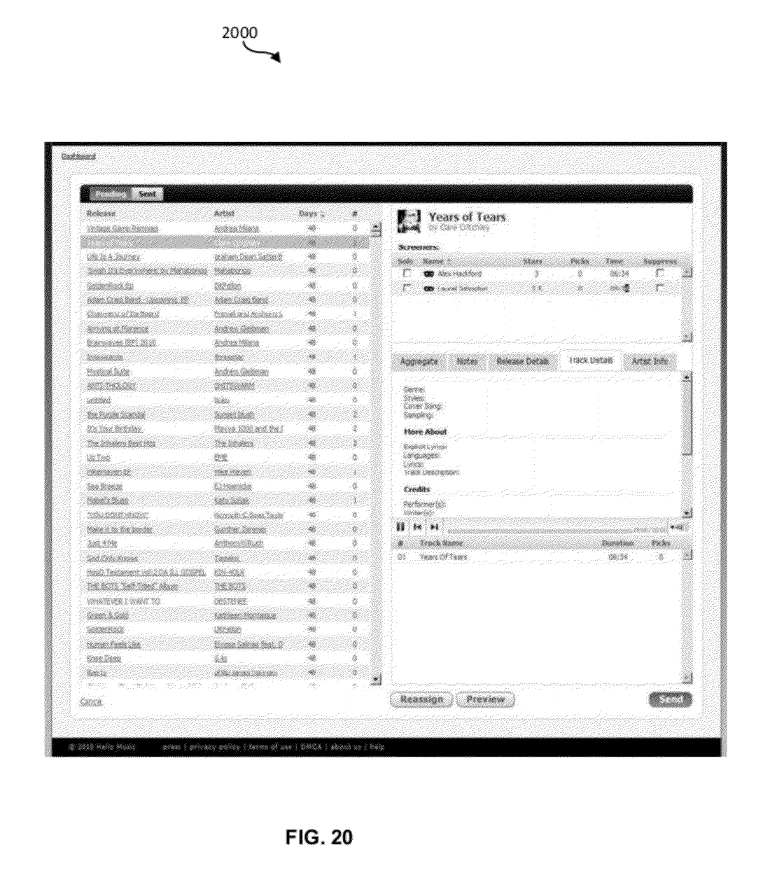

FIG. 20 shows a “screener/moderator—reviewed track details” user interface 2000 for the system and method for media evaluation. Here, a screener/moderator may view track details related to the media.

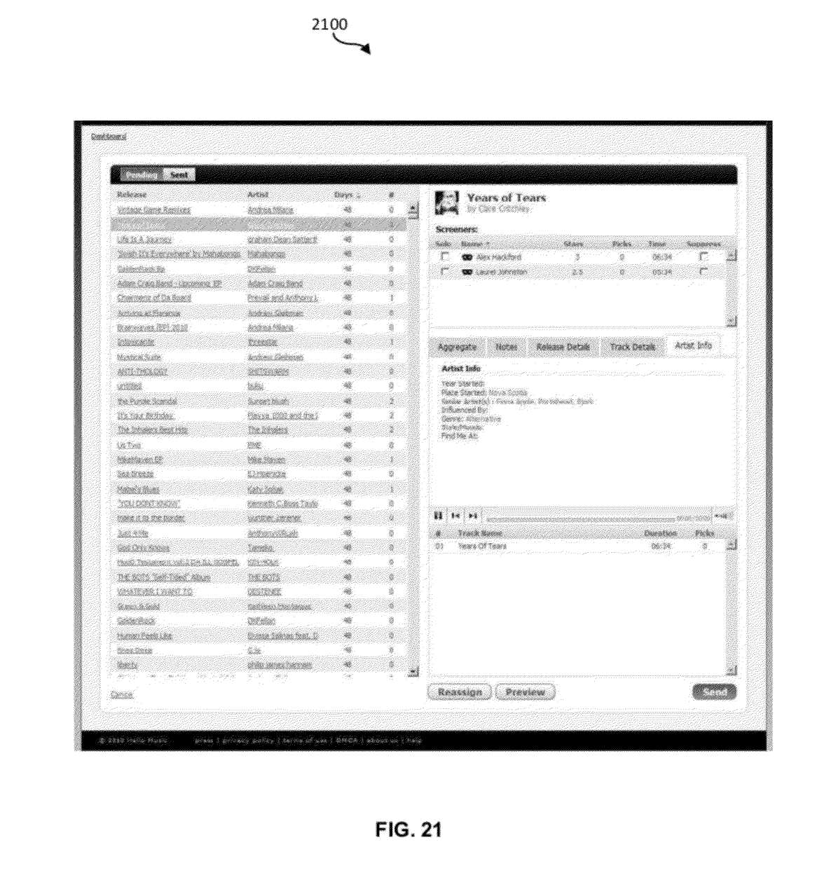

FIG. 21 shows a “screener/moderator—reviewed artist information” user interface 2100 for the system and method for media evaluation. Here, a screener/moderator may view artist information related to the media.

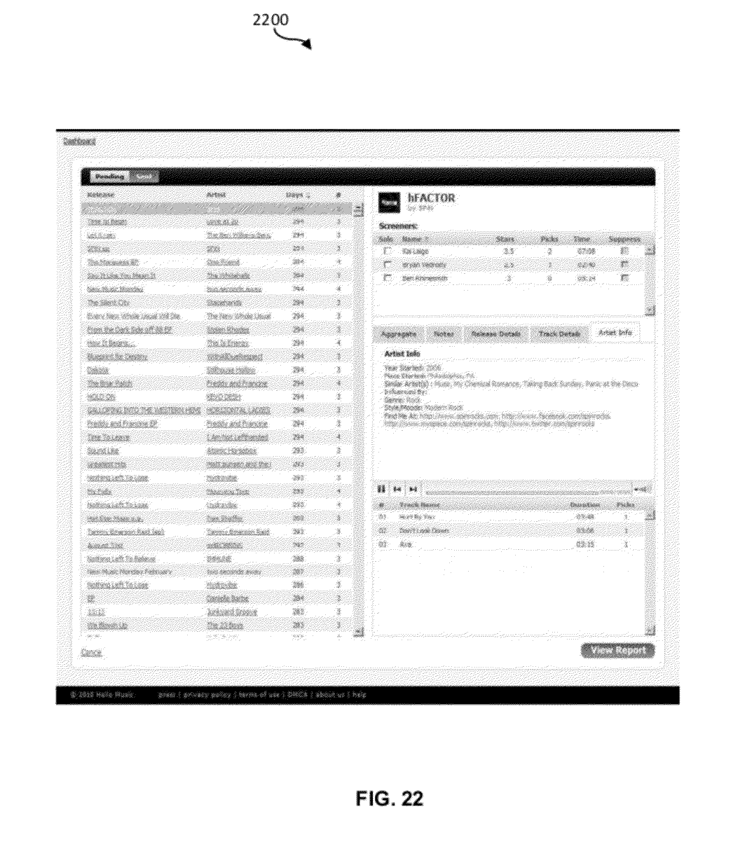

FIG. 22 shows “screener/moderator—reviewed sent” user interface 2200 for the system and method for media evaluation. Here, the screener/moderator has clicked the “sent” button and is viewing the artist information for the first listed release.

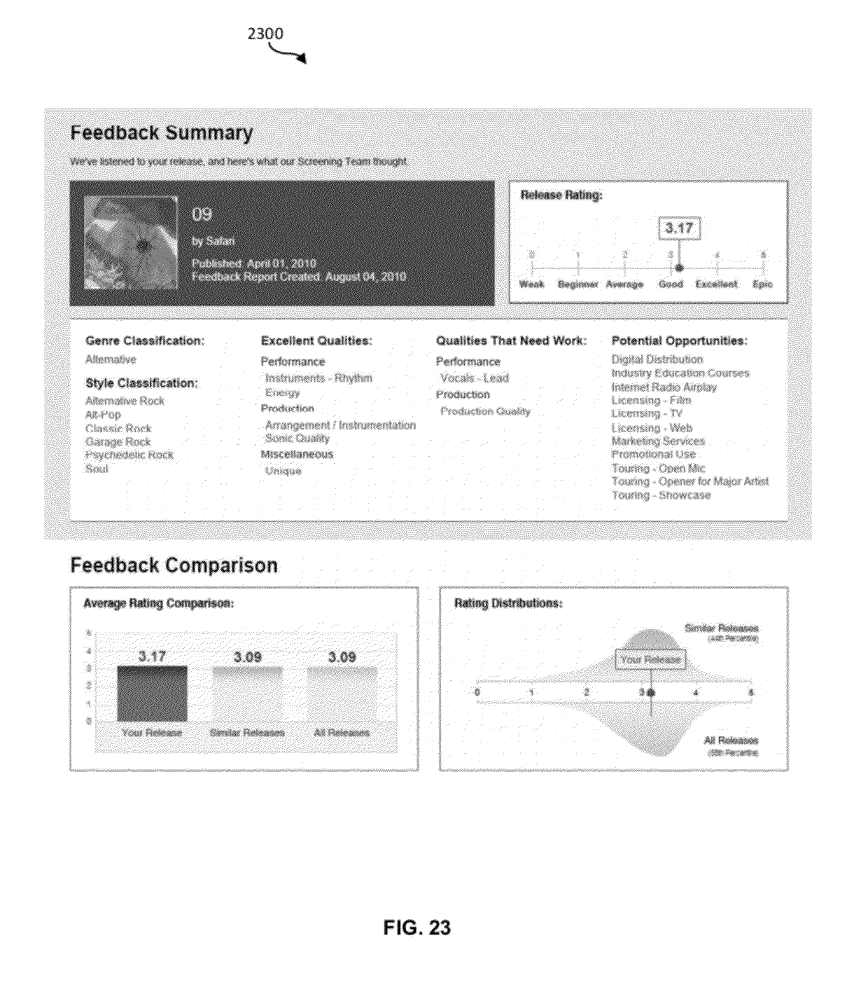

FIG. 23 shows a first portion 2300, including a feedback summary and feedback comparison, of a feedback summary report.

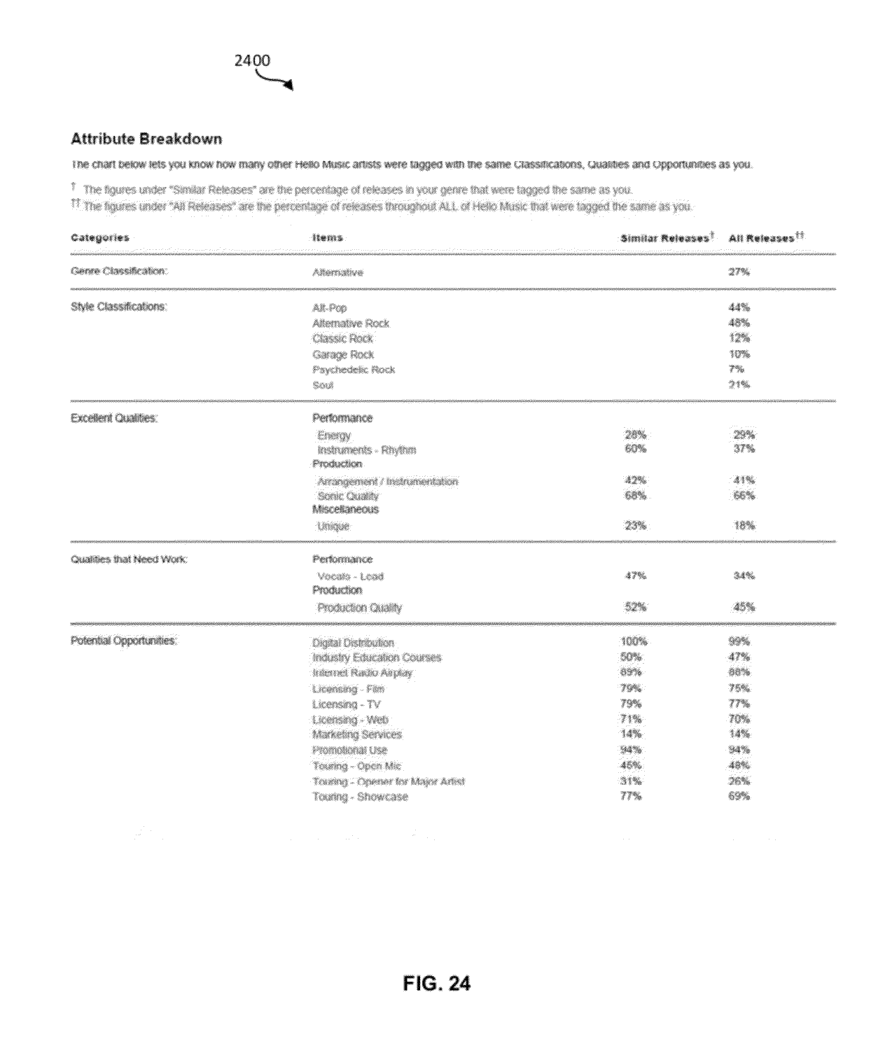

FIG. 24 shows a second portion 2400, including an attribute breakdown, of a feedback summary report.

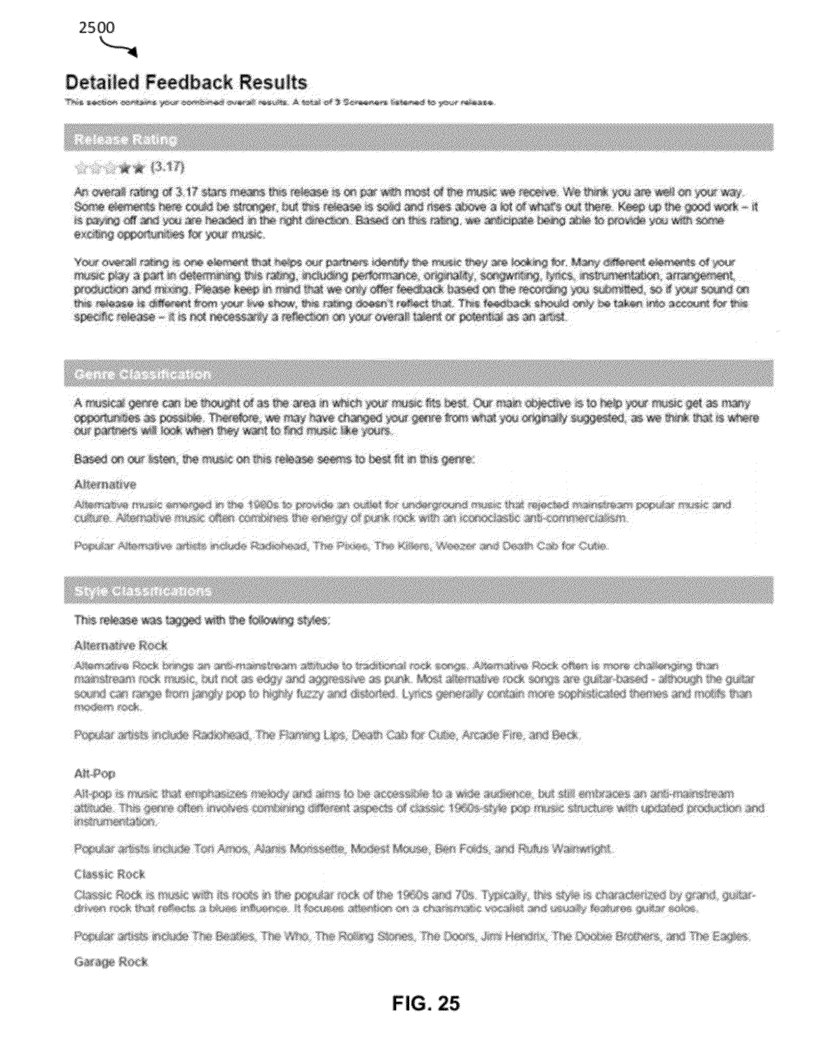

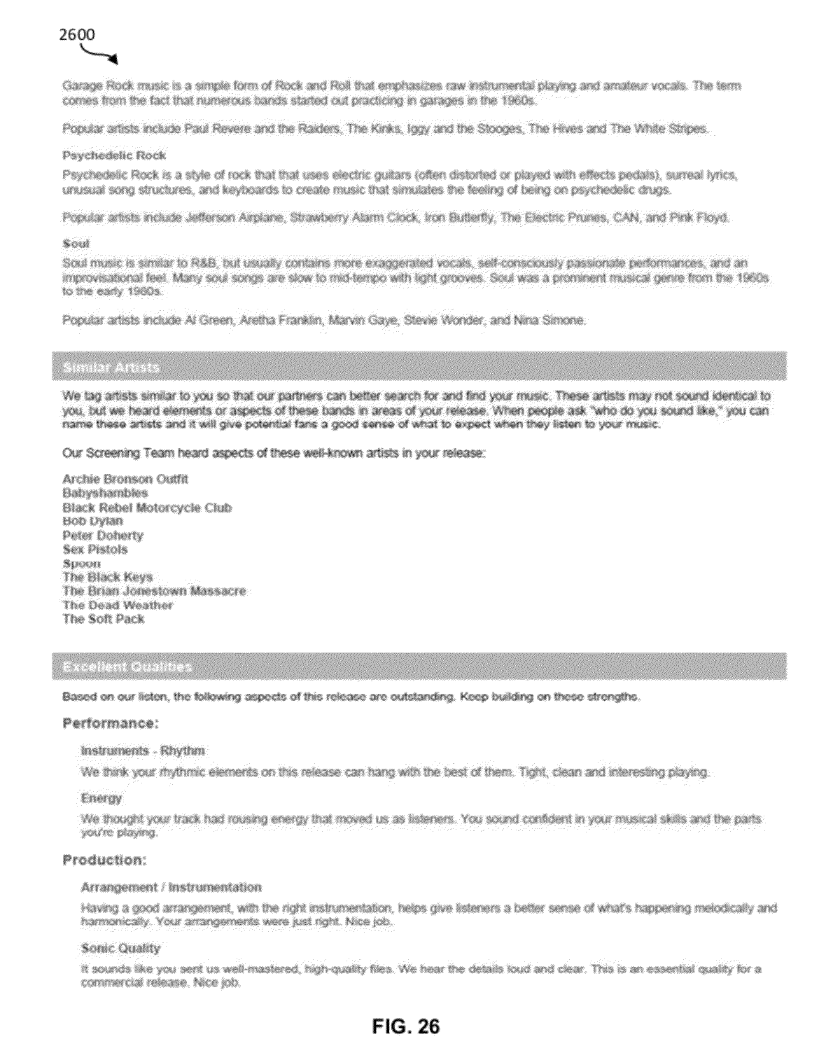

FIGS. 25 and 26 show a third portion 2500 and fourth portion 2600, including detailed feedback results, of a feedback summary report.

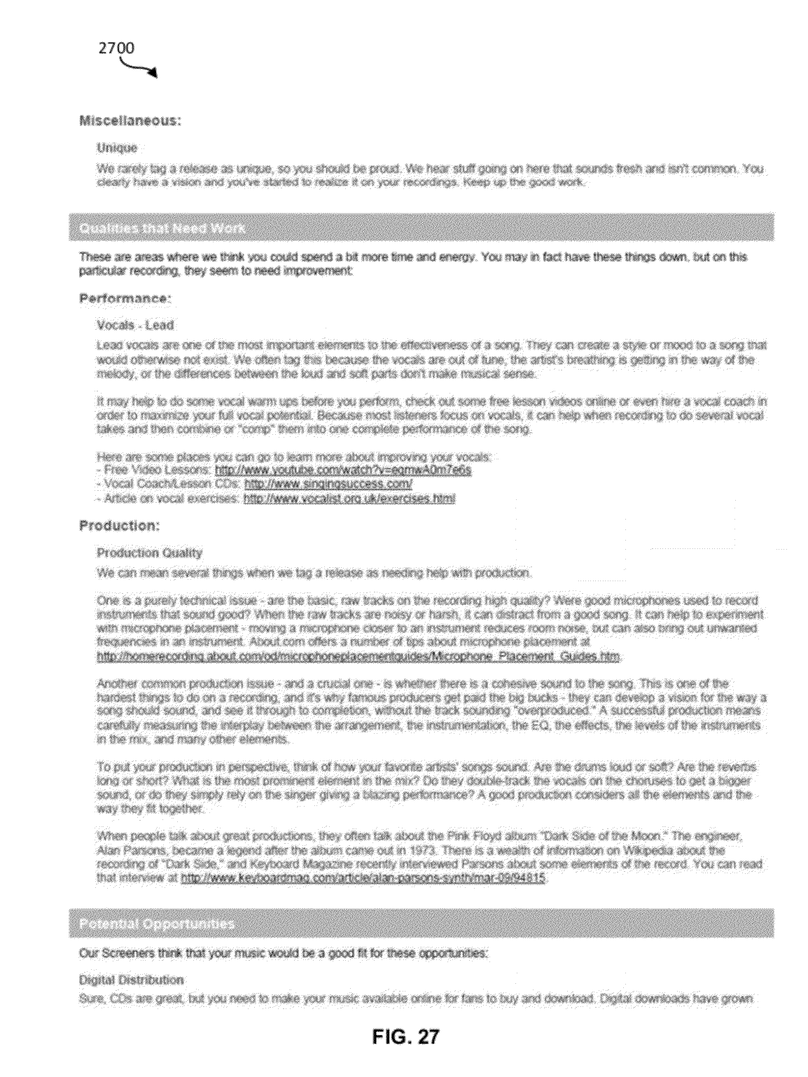

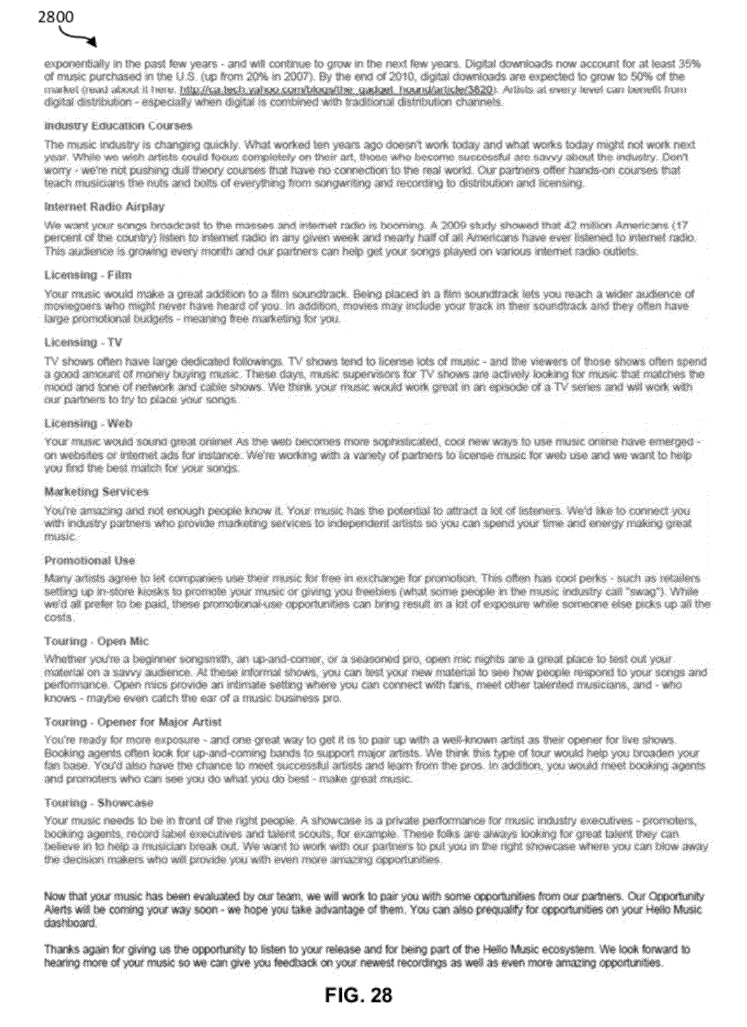

FIGS. 27 and 28 shows a fifth portion 2700 and a sixth portion 2800, including qualities that may need work and potential opportunities, of a feedback summary report.

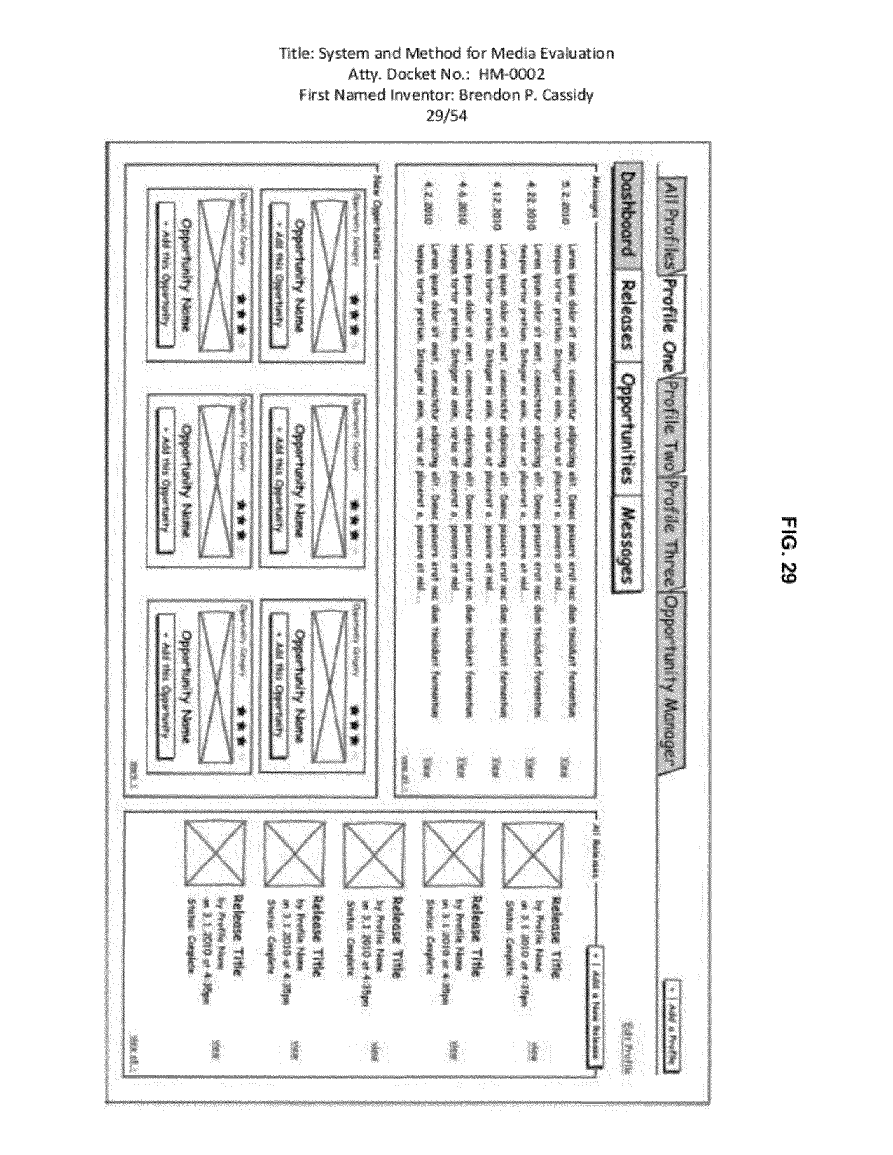

FIGS. 29 to 43 show a dashboard and opportunity management interface. A user may view all profiles, or particular profiles of interest (e.g., as shown by tabs). A dashboard provides an overview of messages, new opportunities, and the user's releases (see FIG. 29).

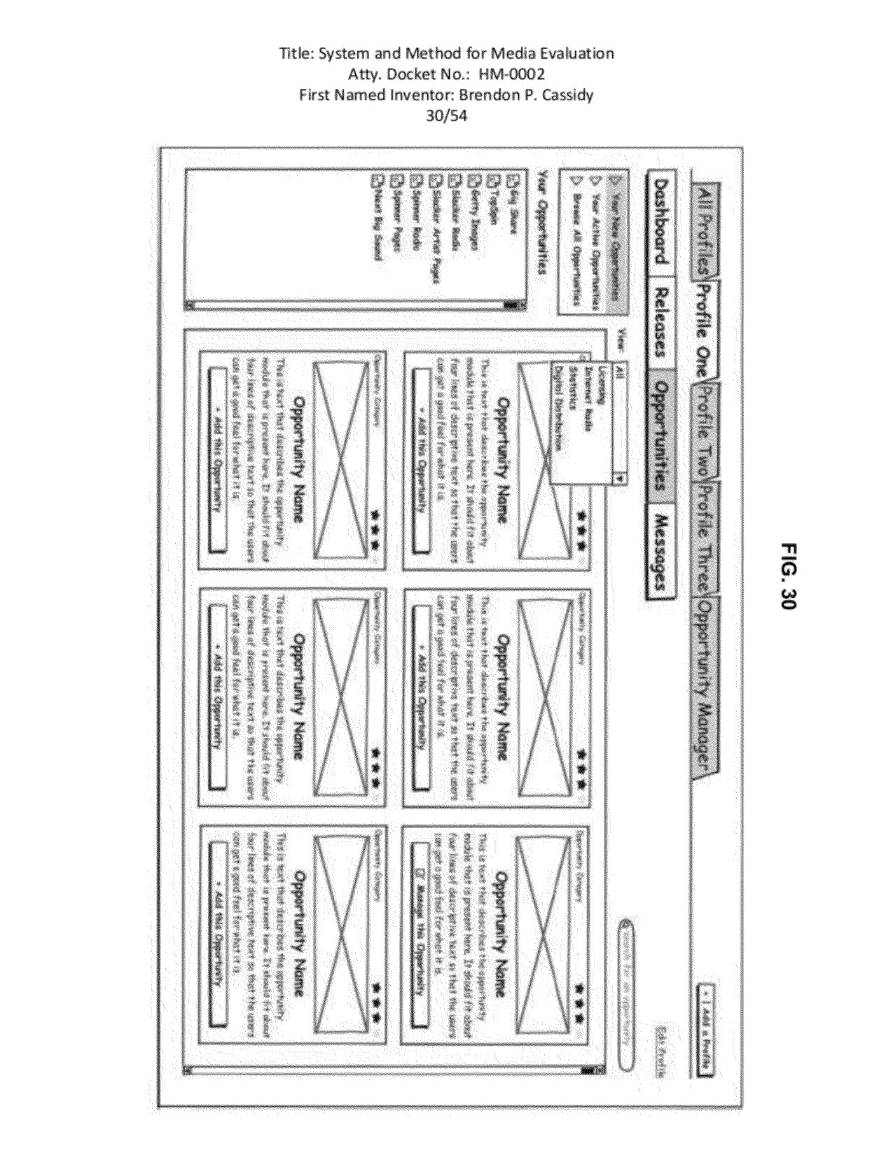

The opportunities are shown as new opportunities, active opportunities, and the user may browse all opportunities (see FIG. 30). The opportunities may also be shown on a scroll list for easy viewing. The opportunities may be shown with a “star” rating that indicates their desirability. Moreover, the opportunity may be shown with an image, the name, and a short text that describes the opportunity module shown. It may be descriptive so that the user has a good feel for what the opportunity comprises. The user may add the opportunity to their profile by clicking a button on the opportunity module.

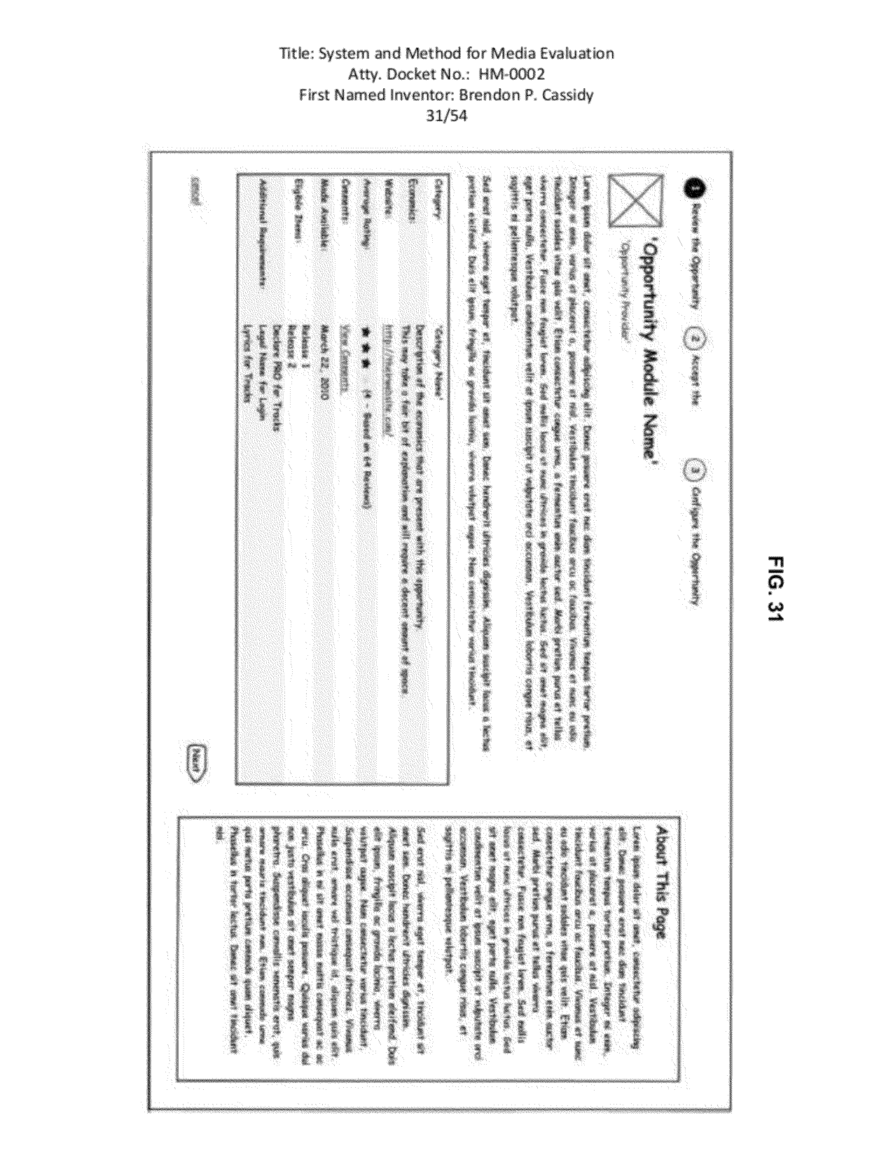

The user may also drill down into the opportunity for more detail (see FIG. 31). When done, the opportunity module name is shown with a more detailed description. The category, economics (e.g., a description of the economics present with the opportunity are shown in detail), a website address for the opportunity, a rating (e.g., rating by others), comments, date made available, eligible items (e.g., the user's releases that are eligible), and additional requirements (e.g., PRO for tracks, legal name, and lyrics).

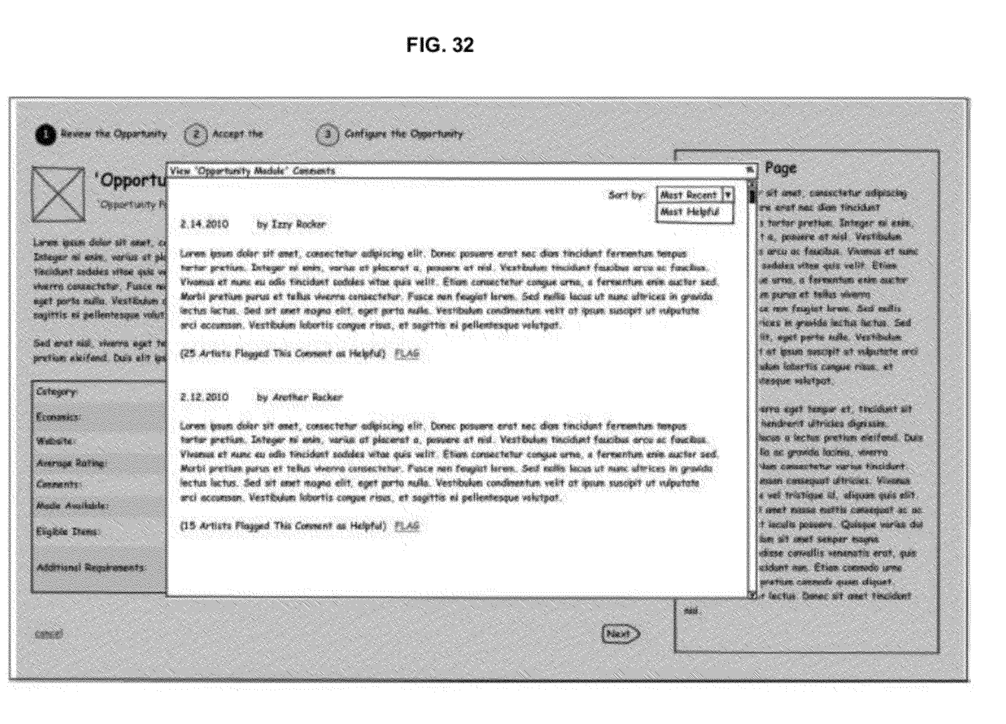

Comments may be viewed and reviewed, listed by most recent, most helpful, etc. (see FIG. 32).

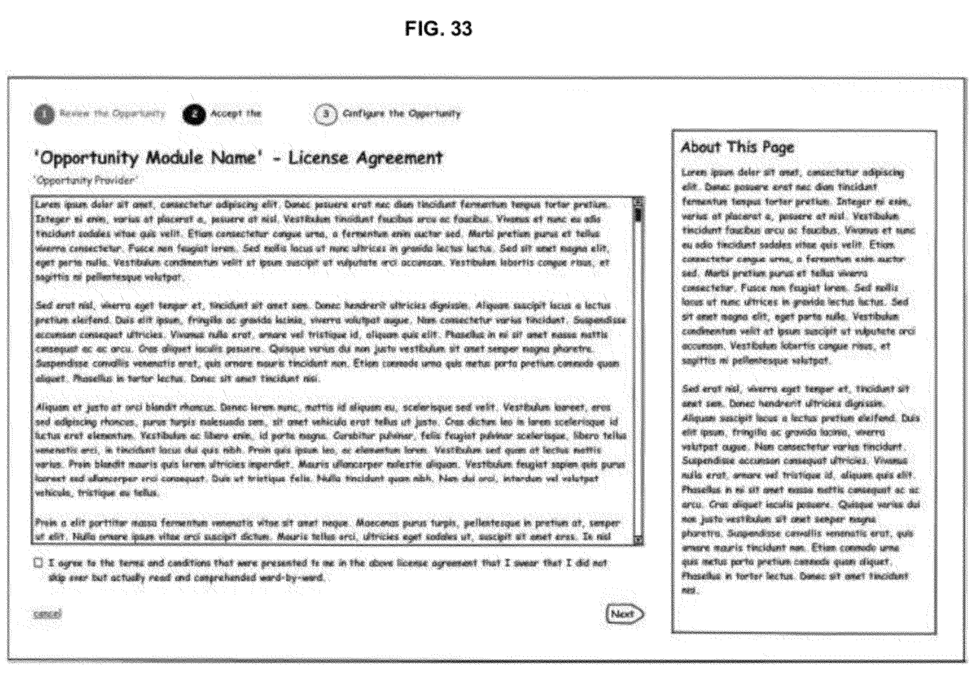

Legal requirement may be necessary to receive an opportunity (see FIG. 33). An example is shown where the user must agree to the license agreement before receiving an opportunity. If the user agrees, they may receive the opportunity. If the user does not agree, they may not receive the opportunity.

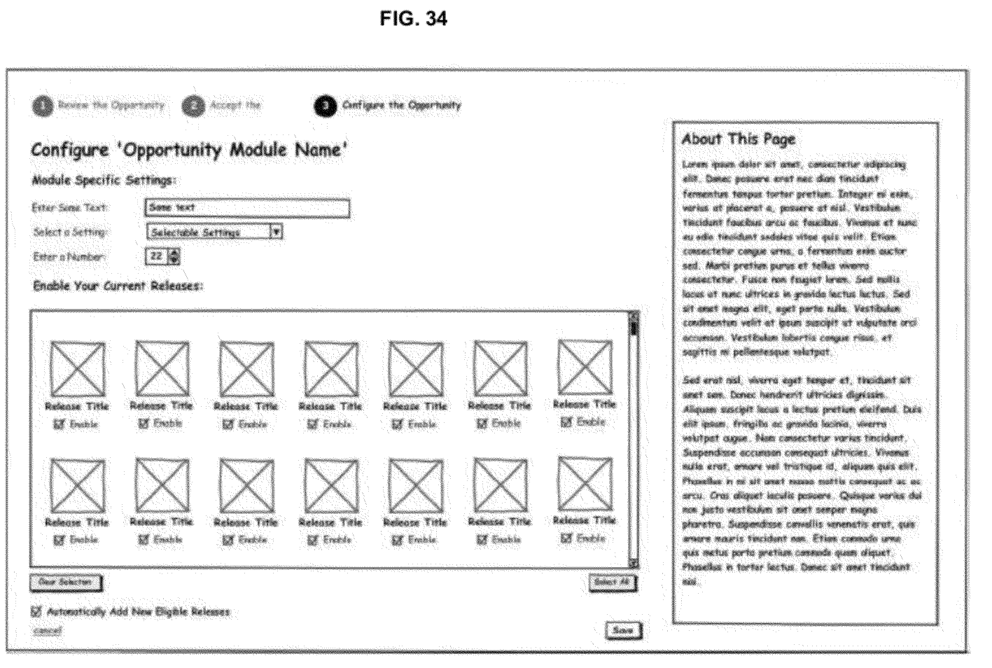

A user may configure the opportunity module settings (see FIG. 34). The user may also enable or disable current releases, and may also decide to automatically enable new releases.

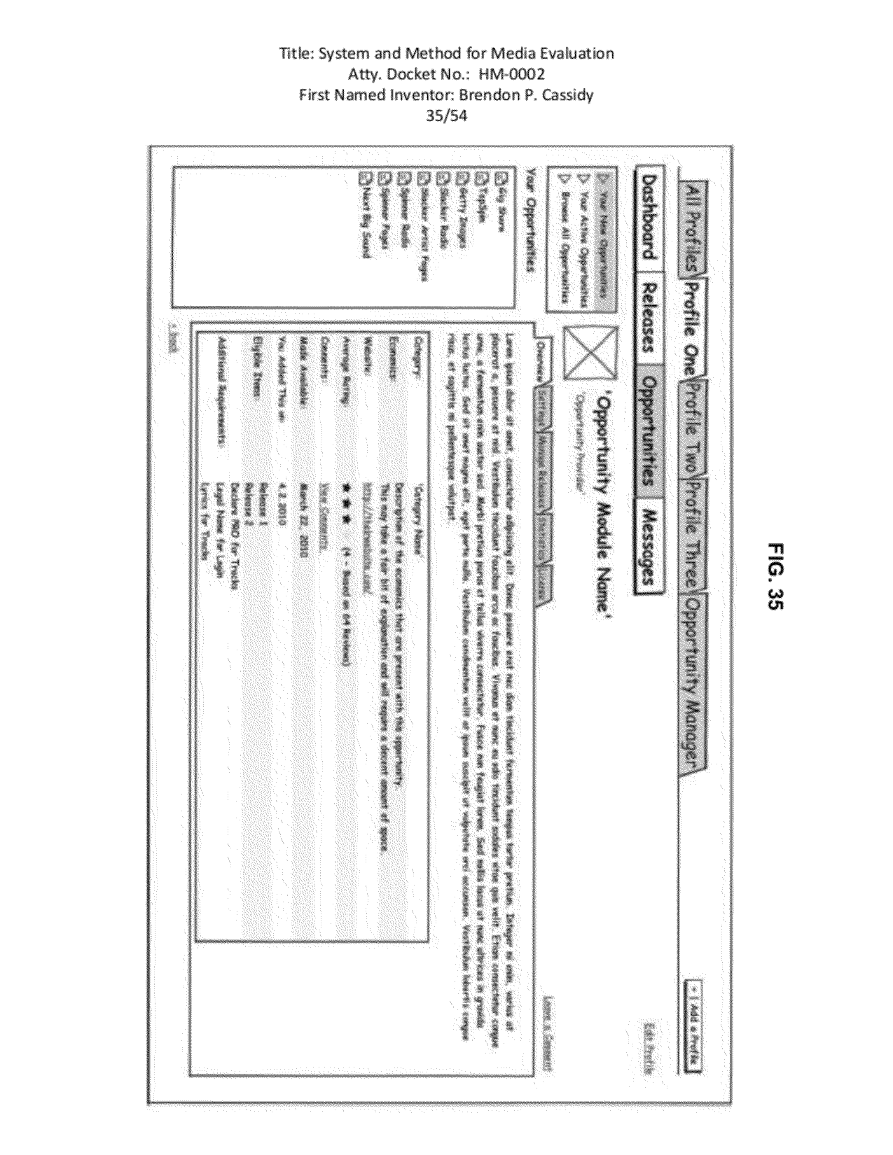

The user may also view the opportunity by tabs (see FIG. 35). Here, the user may tab between the overview, the settings, manage releases, statistics, and the opportunity license, if any.

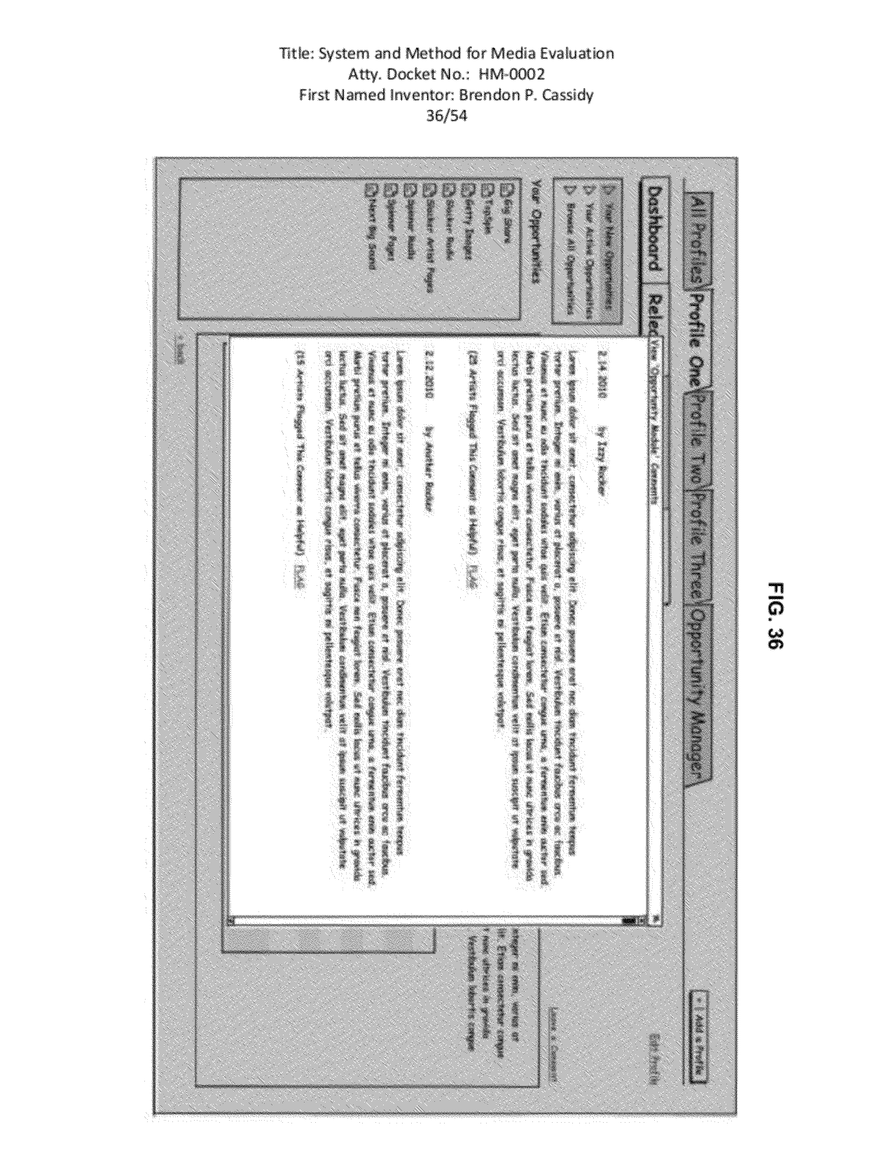

The user may also see the opportunity module's comments by other users, and flag those comments helpful if desired (see FIG. 36).

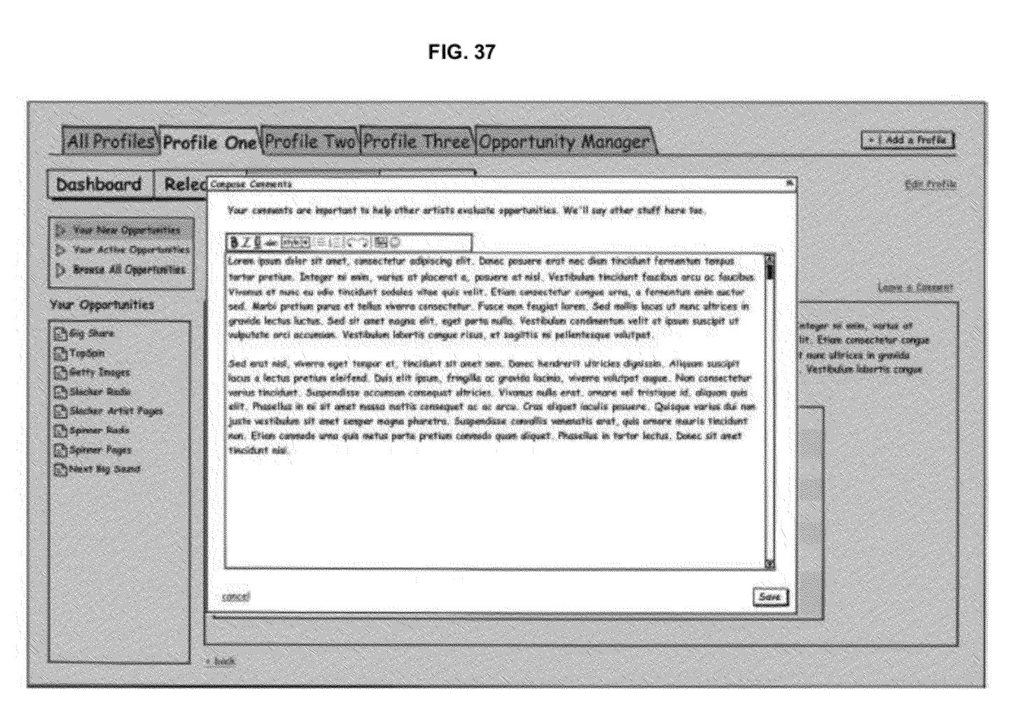

The user may also compose comments on the opportunity for sharing with other users (see FIG. 37).

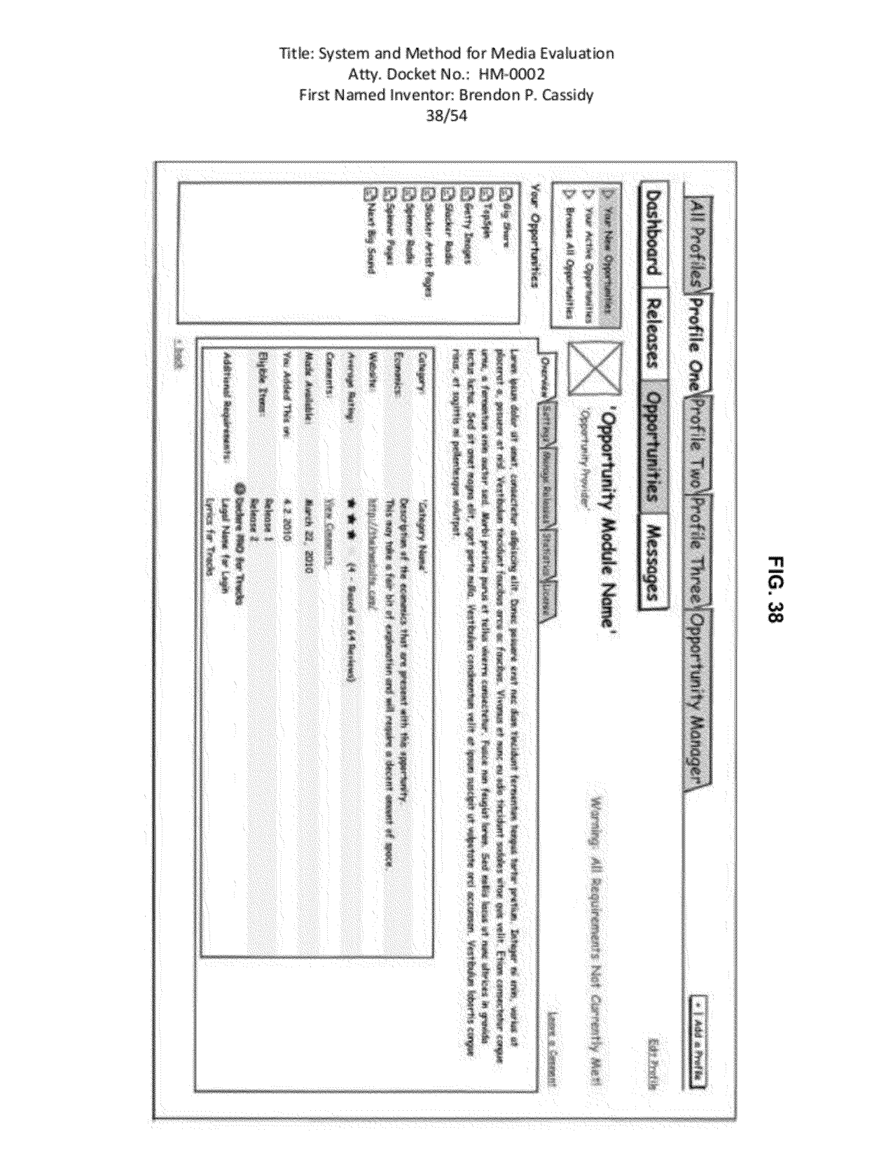

The system may indicate to the user that not all requirements are met (see FIG. 38). As shown in the example, the user has not met the additional requirement of declaring PRO for the tracks.

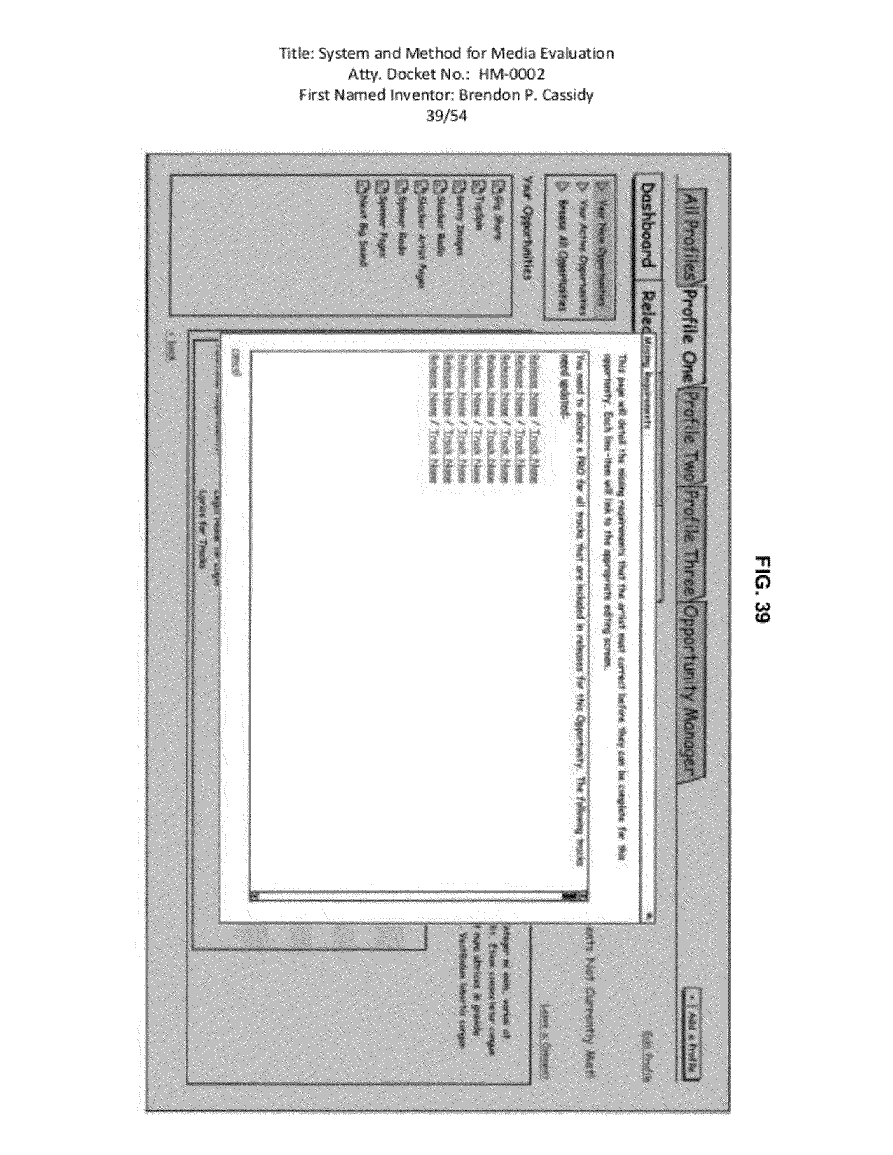

The system may guide the user to the user interface to fulfill the requirements, such as the release name and track name (see FIG. 39).

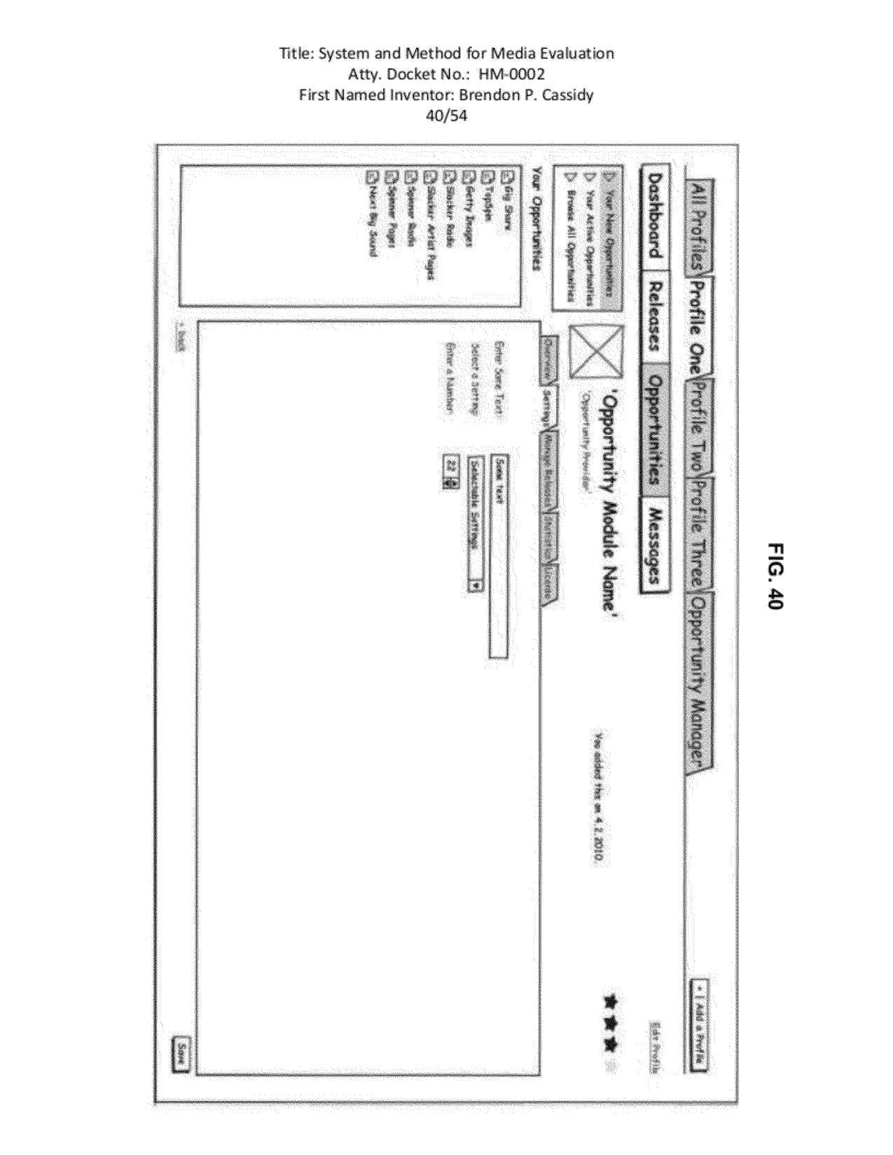

In a settings tab, the user may enter a description of the stetting, select a setting and then enter a value for the setting (see FIG. 40).

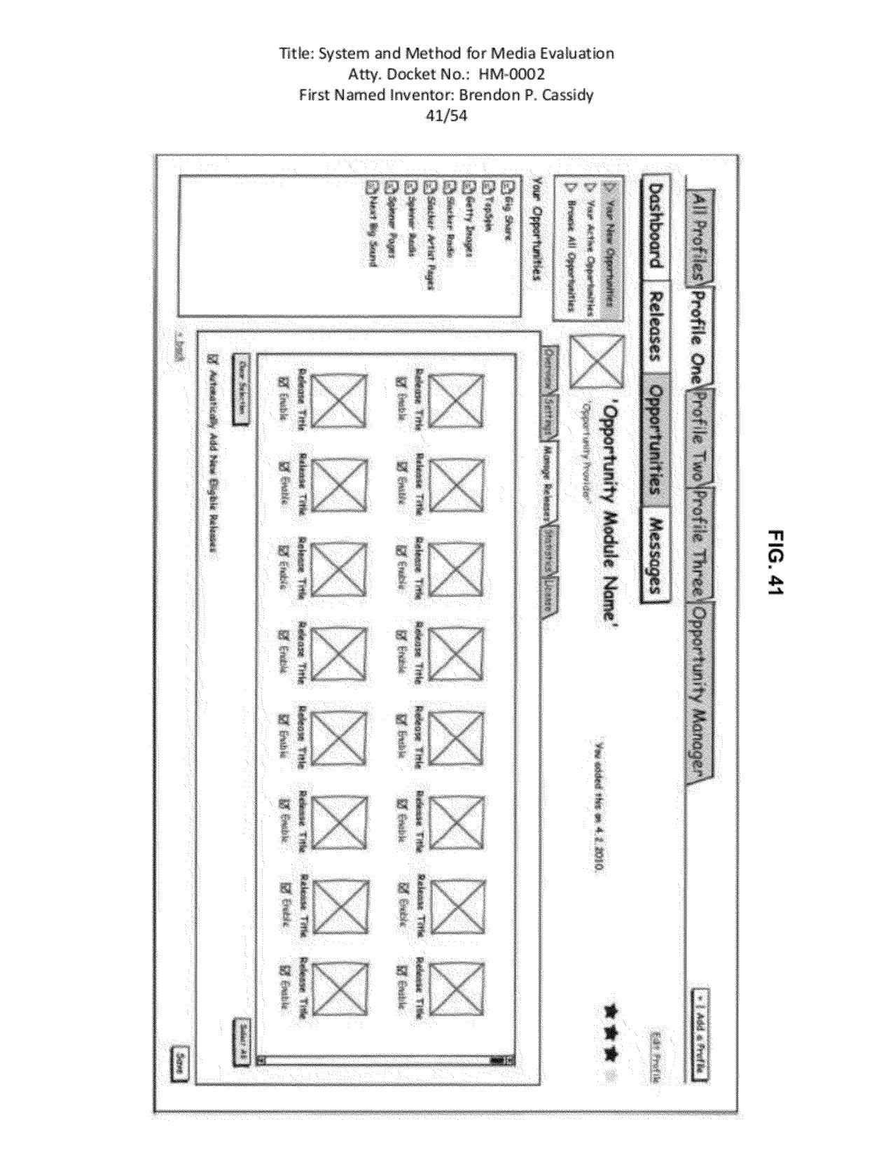

In the manage releases tab, the user may manage their releases by enabling or disabling them for the opportunity module (see FIG. 41).

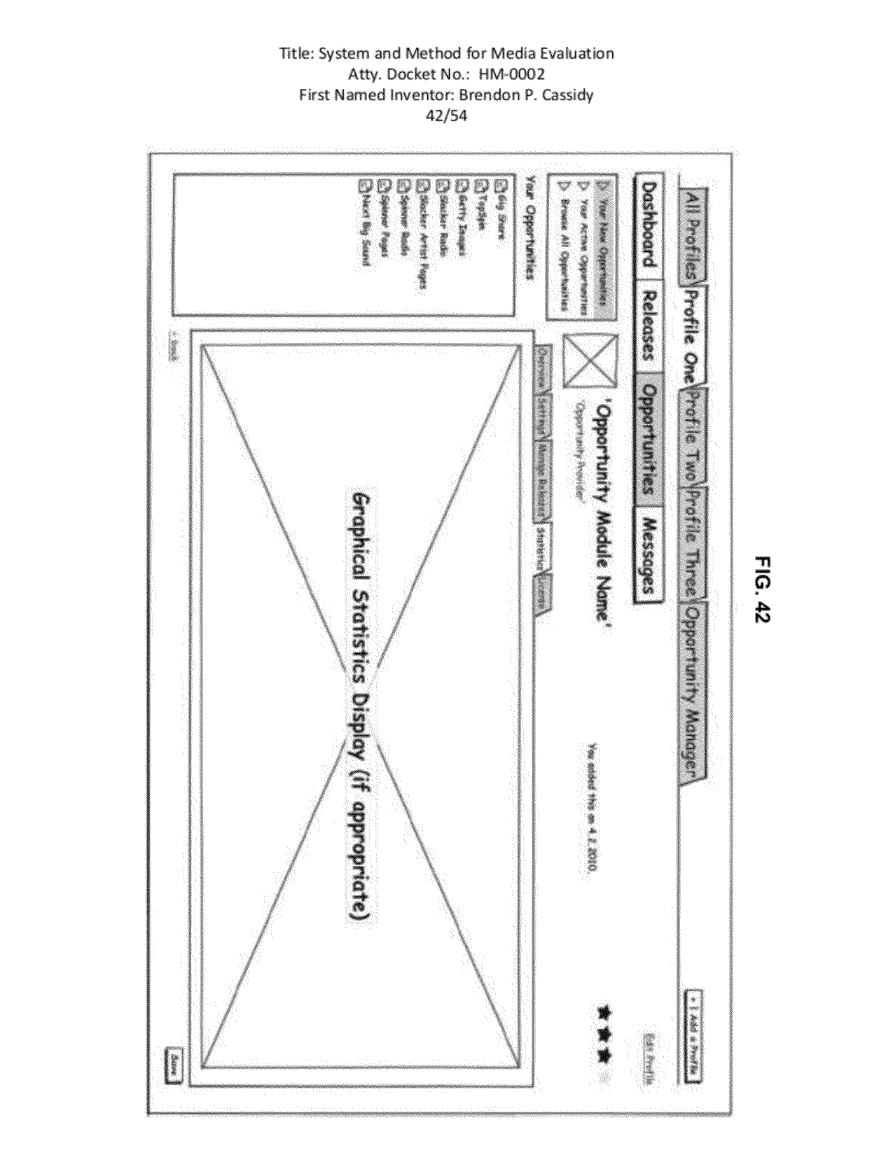

In the statistics tab, the user may see a graphical statistics display, if appropriate (see FIG. 42).

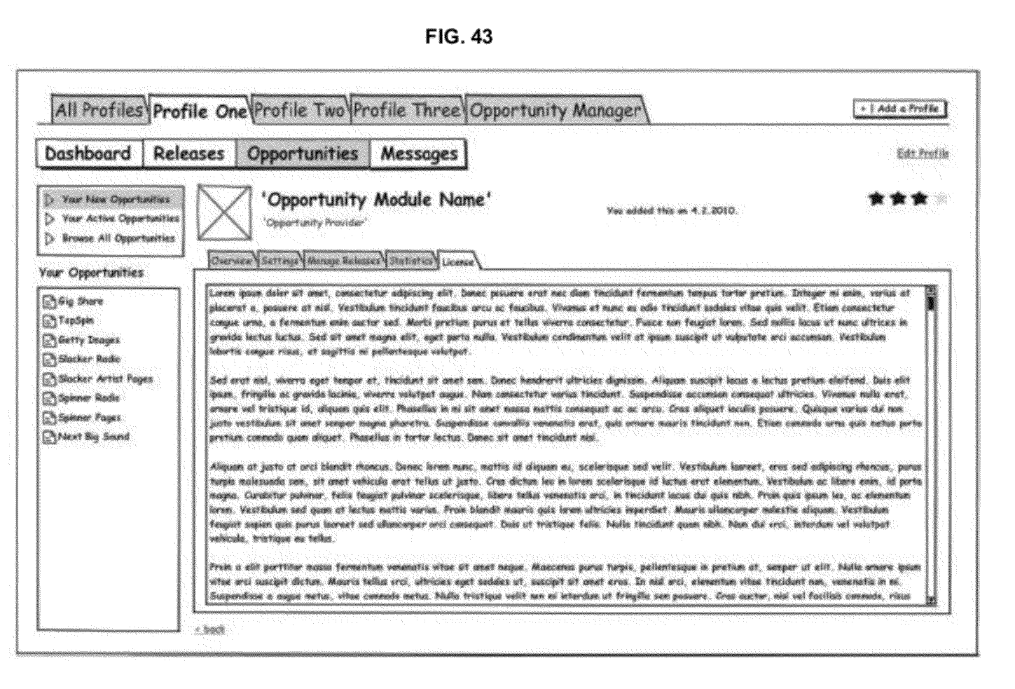

In the license tab, the user may view the license associated with the opportunity (see FIG. 43).

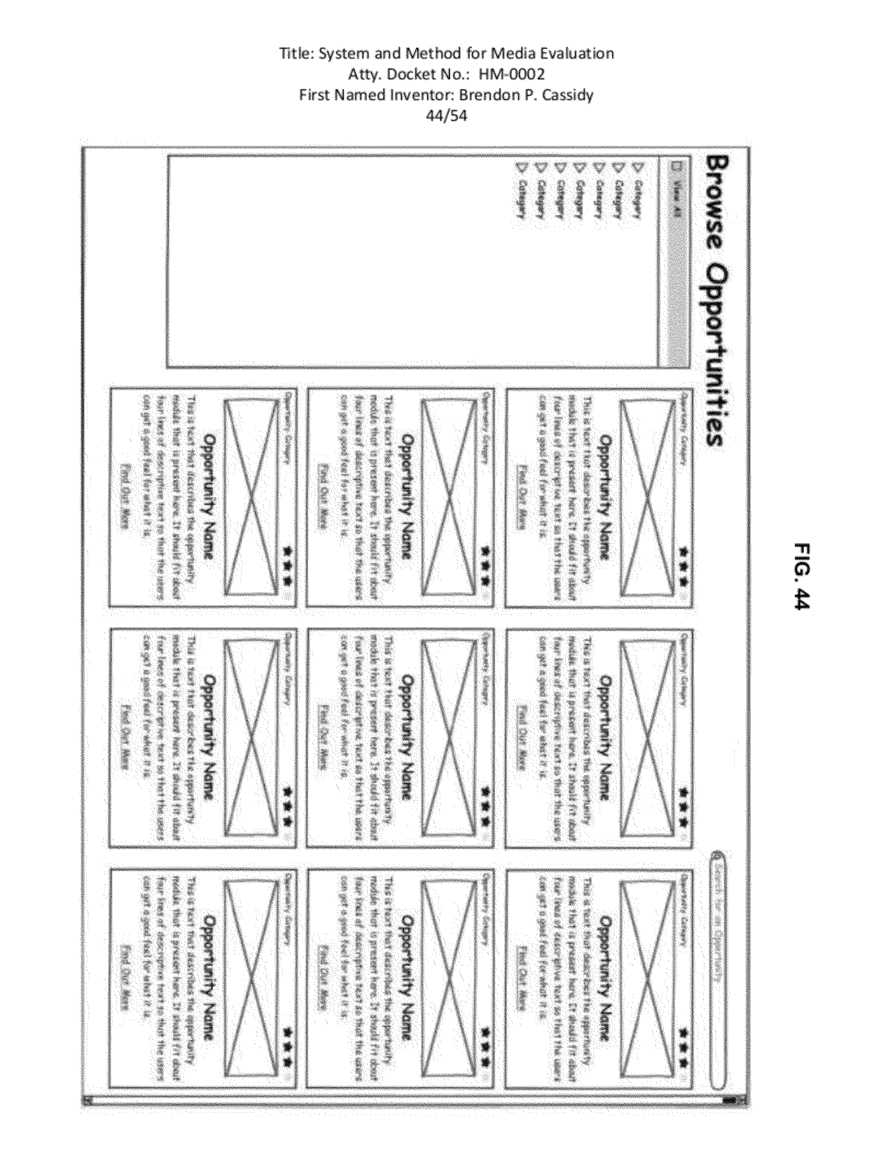

FIGS. 44 to 46 show an opportunity browsing interface. The user may view all opportunities, browse by category, or search for an opportunity. The results are shown with the opportunity category, a star rating, an image, the opportunity name, and a short description. It may also provide a link to find out more details about the opportunity.

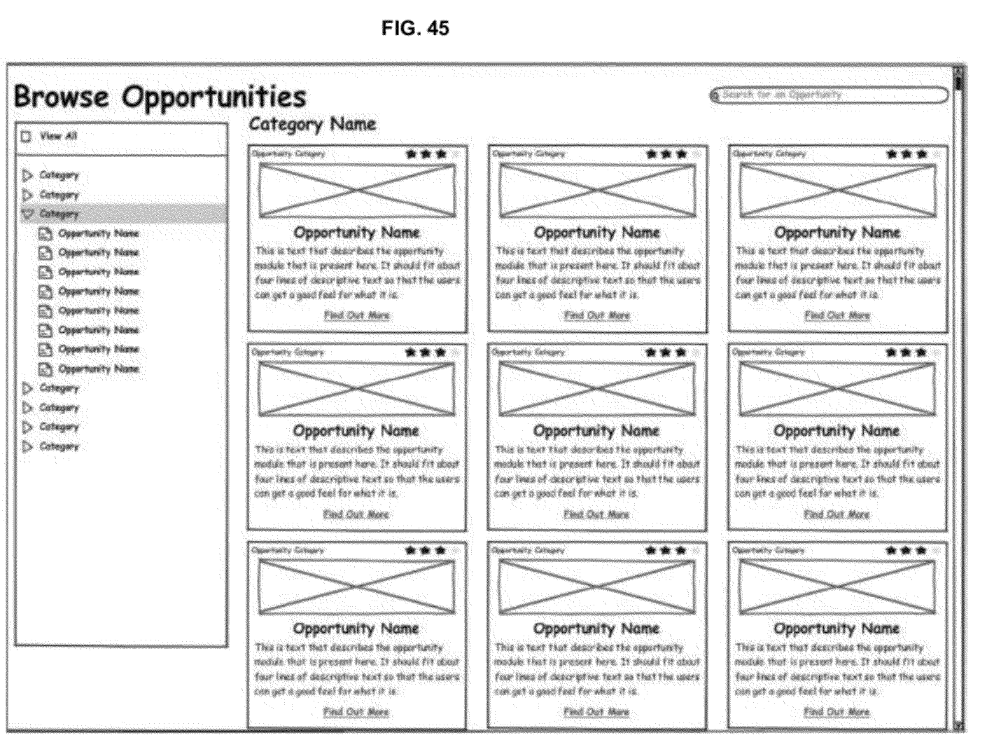

The user may browse by category (see FIG. 45).

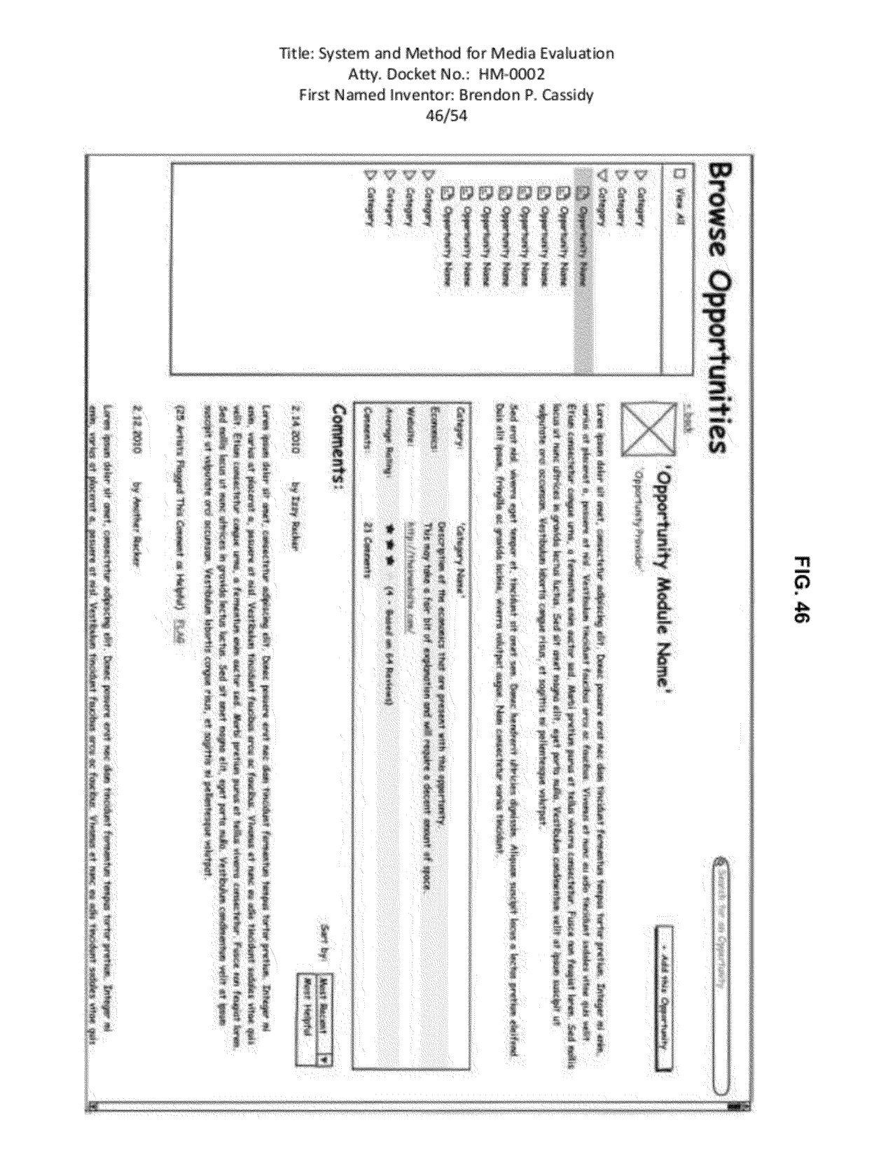

If the user drills down into the opportunity detail, they may see the opportunity name, the opportunity provider, a description, category, economics, website, and comments (see FIG. 46).

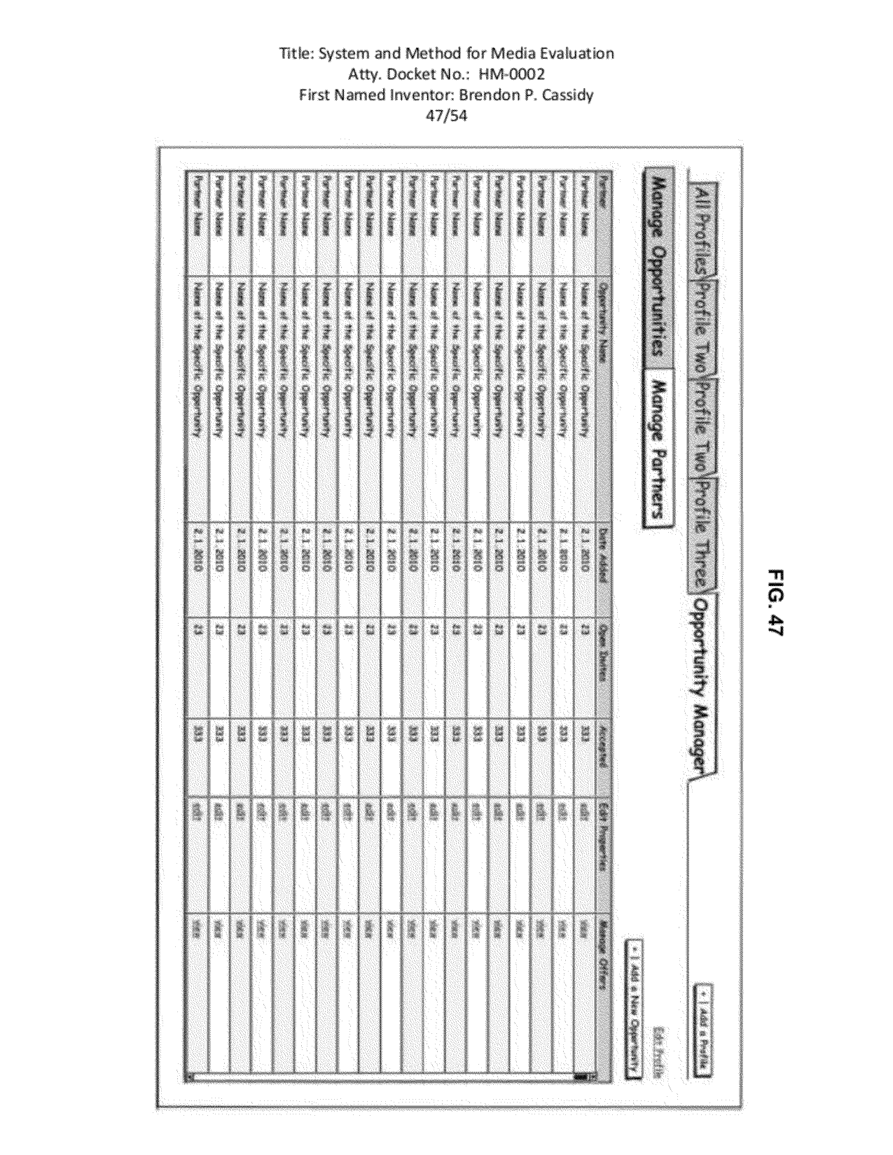

FIGS. 47 to 54 show an opportunity administration interface. An opportunity administrator may manage opportunities and partners. A list of partners and opportunities may be reviewed and modified. The opportunity administrator may also add a profile and add opportunities. Examples are shown with a list of opportunities, including the partner name, name of the specific opportunity, date added, open invites, accepted invites, properties and offer management.

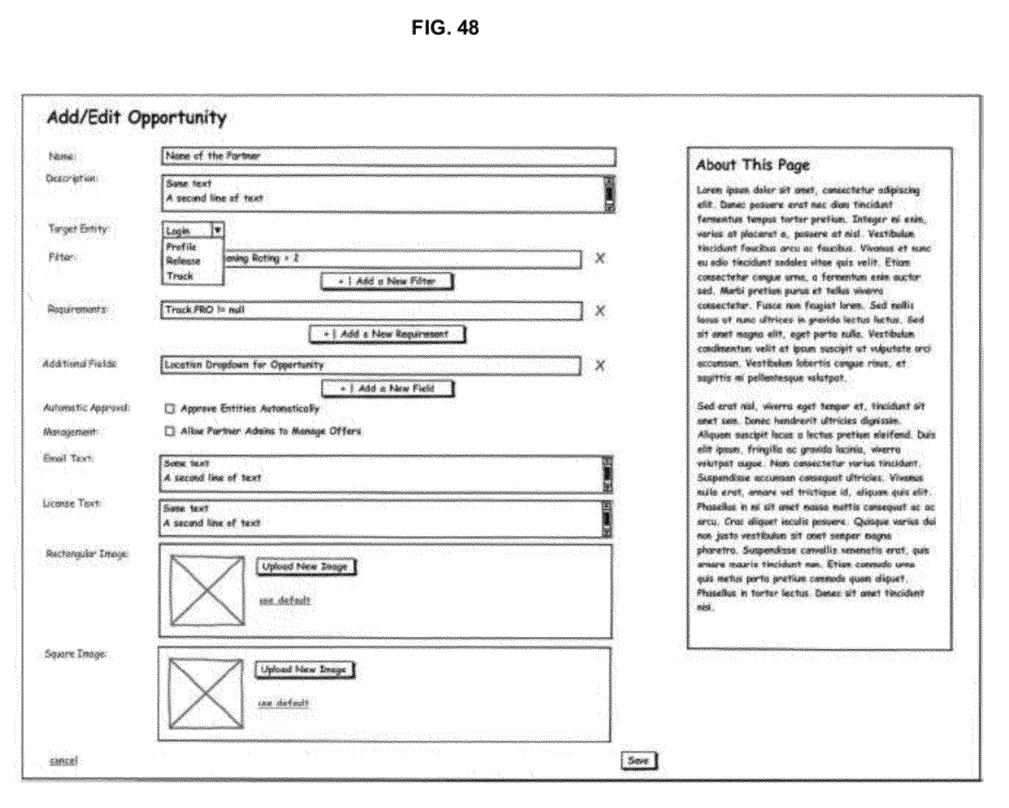

Adding or editing an opportunity may be performed by user interface as shown in the example (see FIG. 48). The name of the partner may be entered, a description of the opportunity may be added, a target entity may be input, a filter may be provided, or a new filter may be created, a requirements section may be defined, additional files may be entered, automatic approval may be selected, management access may be granted to partners, a standard email text may be entered, license text may be entered, and images may be uploaded.

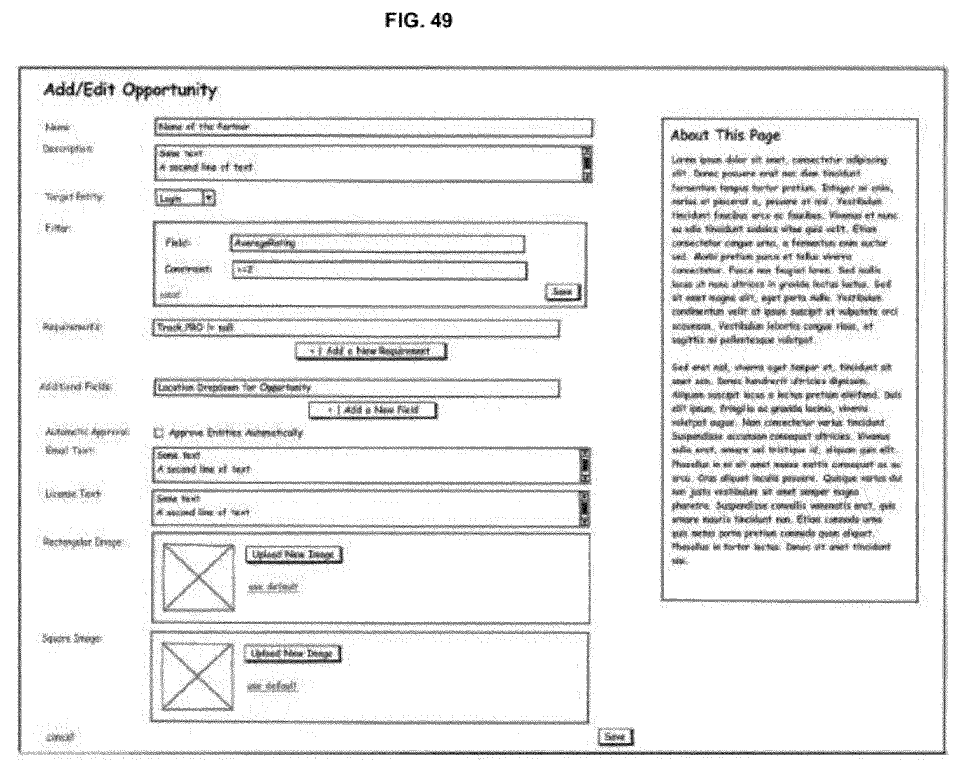

The filter may include a field and a constraint (see FIG. 49). In this example, the filter requires an average rating greater than or equal to 2.

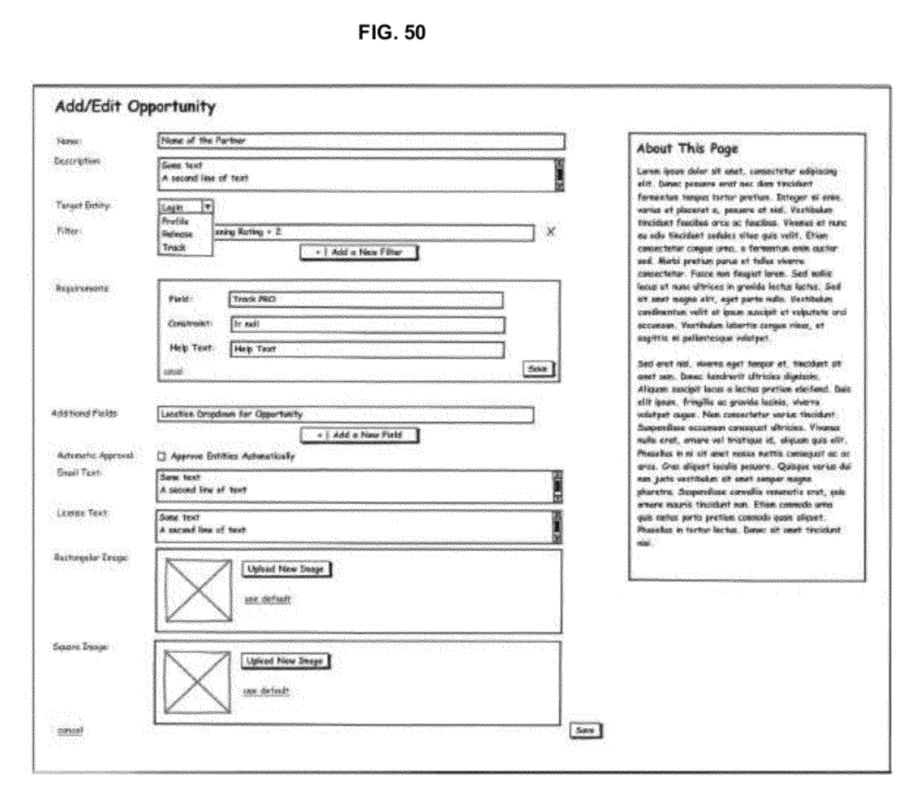

The requirement example shows a track PRO that is not null, and offers helpful text to the user that does not fulfill the requirement (see FIG. 50).

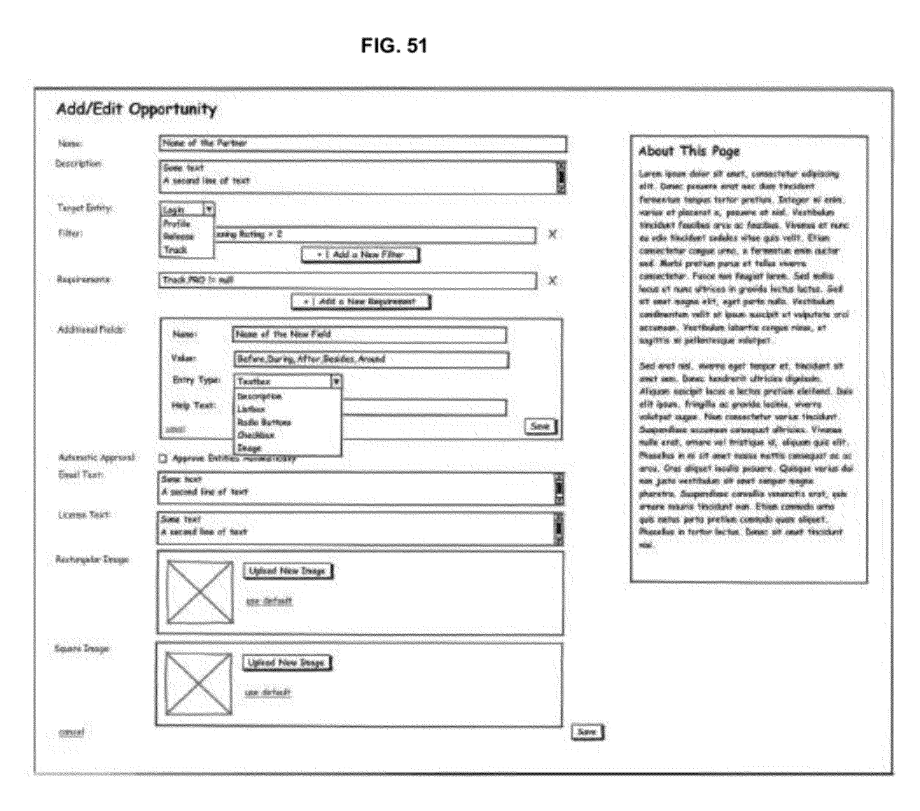

Additional fields are shown that include the name of the field, the value, the entity type and helpful text (see FIG. 51).

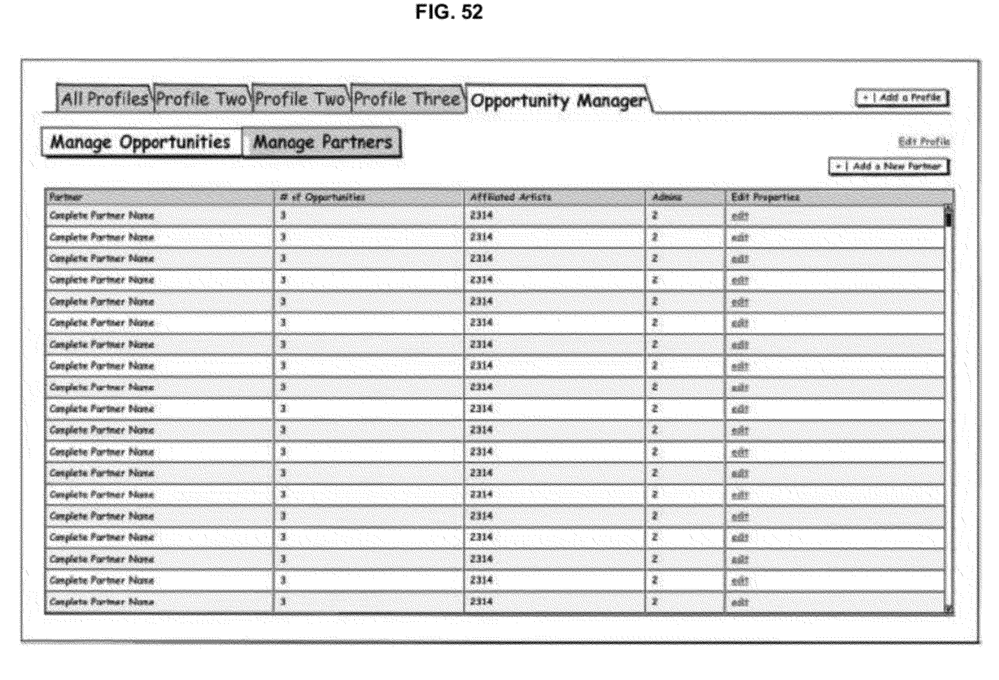

To manage partners, a list of partners may be shown or new partners may be added (see FIG. 52). The list of partners includes the name of the partner, the number of opportunities, the number of affiliated artists, the number of admins, and allows the administrator to edit the partner's properties.

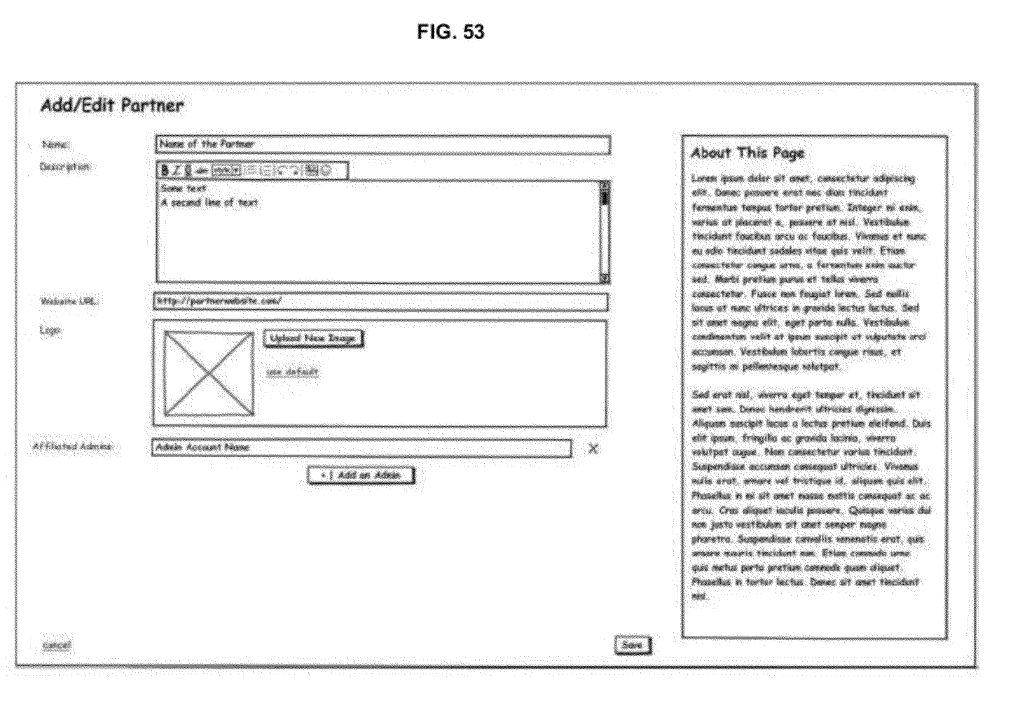

In the add/edit partner user interface (see FIG. 53) the name of the partner may be modified, a description, a website URL, a logo, and affiliated administrators may be added.

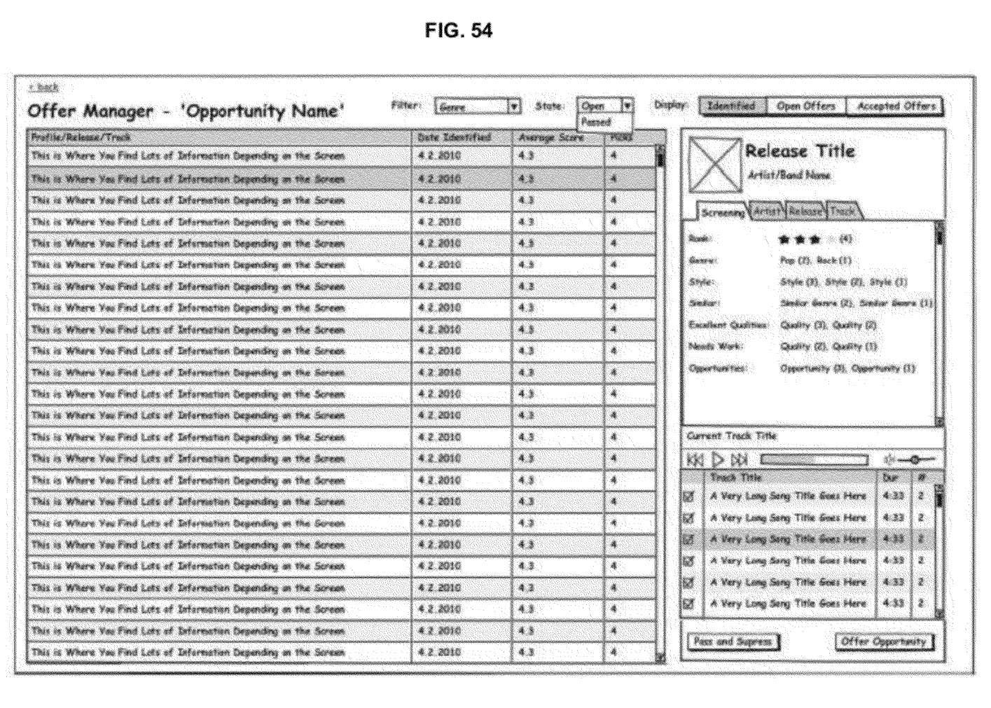

In the offer manager (see FIG. 54), the profile/release/track may be shown, the date identified, the average score and picks may be shown in a list. The display can be selected by identified, open offers, and accepted offers. The offers may be filtered by genre and state (open, passed, etc.). The release title may be shown with the artist, band, screening information as well as the release and track (which can be viewed and listened to). The administrator may also pass and suppress the current track or offer the opportunity.

The entirety of this disclosure (including the Cover Page, Title, Headings, Field, Background, Summary, Brief Description of the Drawings, Detailed Description, Claims, Abstract, Figures, and otherwise) shows by way of illustration various embodiments in which the claimed inventions may be practiced. The advantages and features of the disclosure are of a representative sample of embodiments only, and are not exhaustive and/or exclusive. They are presented only to assist in understanding and teach the claimed principles. It should be understood that they are not representative of all claimed inventions. As such, certain aspects of the disclosure have not been discussed herein. That alternate embodiments may not have been presented for a specific portion of the invention or that further undescribed alternate embodiments may be available for a portion is not to be considered a disclaimer of those alternate embodiments. It will be appreciated that many of those undescribed embodiments incorporate the same principles of the invention and others are equivalent. Thus, it is to be understood that other embodiments may be utilized and functional, logical, organizational, structural and/or topological modifications may be made without departing from the scope and/or spirit of the disclosure. As such, all examples and/or embodiments are deemed to be non-limiting throughout this disclosure. Also, no inference should be drawn regarding those embodiments discussed herein relative to those not discussed herein other than it is as such for purposes of reducing space and repetition. For instance, it is to be understood that the logical and/or topological structure of any combination of any program components (a component collection), other components and/or any present feature sets as described in the figures and/or throughout are not limited to a fixed operating order and/or arrangement, but rather, any disclosed order is exemplary and all equivalents, regardless of order, are contemplated by the disclosure. Furthermore, it is to be understood that such features are not limited to serial execution, but rather, any number of threads, processes, services, servers, and/or the like that may execute asynchronously, concurrently, in parallel, simultaneously, synchronously, and/or the like are contemplated by the disclosure. As such, some of these features may be mutually contradictory, in that they cannot be simultaneously present in a single embodiment. Similarly, some features are applicable to one aspect of the invention, and inapplicable to others. In addition, the disclosure includes other inventions not presently claimed. Applicant reserves all rights in those presently unclaimed inventions including the right to claim such inventions, file additional applications, continuations, continuations in part, divisions, and/or the like thereof. As such, it should be understood that advantages, embodiments, examples, functional, features, logical, organizational, structural, topological, and/or other aspects of the disclosure are not to be considered limitations on the disclosure as defined by the claims or limitations on equivalents to the claims.

All terms used in the claims are intended to be given their broadest reasonable constructions and their ordinary meanings as understood by those skilled in the art unless an explicit indication to the contrary is made herein. In particular, use of the singular articles such as “a,” “the,” “said,” etc. should be read to recite one or more of the indicated elements unless a claim recites an explicit limitation to the contrary.

Accordingly, it is to be understood that the above description is intended to be illustrative and not restrictive. Many embodiments and applications other than the examples provided will be apparent upon reading the above description. The scope of the invention should be determined, not with reference to the above description, but should instead be determined with reference to the appended claims, along with the full scope of equivalents to which such claims are entitled. It is anticipated and intended that future developments will occur in the arts discussed herein, and that the disclosed systems and methods will be incorporated into such future embodiments. In sum, it should be understood that the invention is capable of modification and variation and is limited only by the following claims.

1. A media evaluation system comprising:
a release module configured for uploading and description of user-media by a user;
a screener module; and
an opportunity engine configured to compare predetermined criteria to the description of the user-media, and configured to provide opportunities to the user when the predetermined criteria are met.

2. The media evaluation system of claim 1, further comprising:
a public module providing third party access to the user-media.

3. The media evaluation system of claim 1, further comprising:
a publication module configured to push releases to consumer.

4. The media evaluation system of claim 1, further comprising:
a report module configured to compare the description and the user-media with stored information of similar media and generate a report for the user having a score.

5. The media evaluation system of claim 1, further comprising:
a partner module.
